(19) United States
(12) Patent Application Publication
(10) Pub. No.: US 2025/0181323 A1
(43) Pub. Date: Jun. 5, 2025

(54) PAGE PROCESSING METHOD AND APPARATUS, DEVICE, MEDIUM, AND PRODUCT

(71) Applicant: TENCENT TECHNOLOGY (SHENZHEN) COMPANY LIMITED, Shenzhen (CN)

(72) Inventor: Jianjun LONG, Shenzhen (CN)

(73) Assignee: TENCENT TECHNOLOGY (SHENZHEN) COMPANY LIMITED, Shenzhen (CN)

(21) Appl. No.: 19/042,298

(22) Filed: Jan. 31, 2025

Related U.S. Application Data
(63) Continuation of application No. PCT/CN2023/129206, filed on Nov. 2, 2023.

(30) Foreign Application Priority Data
Jan. 18, 2023 (CN) 202310123900.4

(51) Int. Cl. G06F 8/34

(52) U.S. Cl. CPC G06F 8/34

(57) ABSTRACT

A page processing method includes displaying an application editing page, and displaying, in response to a first trigger operation on a variable creation component, a variable creation page corresponding to a variable type; displaying, in response to a variable definition operation triggered on the variable creation page, a target variable corresponding to the variable type; displaying, in response to a second trigger operation on an action adding component in the application editing page, an action event configuration page corresponding to the action adding component; displaying action configuration information corresponding to the target variable, in response to a third trigger operation on the target action event; switching from the action configuration page to display the application editing page based on the value being assigned to the target variable; and rendering and displaying, in response to a fourth trigger operation on a running component in the application editing page, the target variable.

### CROSS-REFERENCE TO RELATED APPLICATIONS

This application is a continuation application of International Application No. PCT/CN2023/129206 filed on Nov. 2, 2023, which claims priority to Chinese Patent Application No. 202310123900.4, filed with the China National Intellectual Property Administration on Jan. 18, 2023, the disclosures of each being incorporated by reference herein in their entireties.

### FIELD

The disclosure relates to the field of computer technologies, and in particular, to a page processing method and apparatus, a device, a medium, and a computer program product.

### BACKGROUND

Currently, program developers can define a variable and assign a value to a variable in a form of complex code with a programming language (for example, the Java language) in an application development framework, and then present a compiled application program to users.

Users (for example, people other than program developers) also may call the variable in the form of complex code (for example, the Java language) in the application development framework, to use this variable. This means that both program developers and users other than program developers may display the entire life cycle of the variable (for example, variable definition, variable value assignment, and variable usage) in the form of complex code. As a result, this increases the technical complexity from variable definition to variable usage.

### SUMMARY

Provided are a page processing method and apparatus, a device, a medium, and a computer program product.

According to an aspect of the disclosure, a page processing method, performed by a computer device includes displaying an application editing page, and displaying, in response to a first trigger operation on a variable creation component in the application editing page, a variable creation page corresponding to a variable type indicated by the variable creation component; displaying, in response to a variable definition operation triggered on the variable creation page, a target variable corresponding to the variable type in the variable creation page; displaying, in response to a second trigger operation on an action adding component in the application editing page, an action event configuration page corresponding to the action adding component, the action event configuration page including at least one action event configured to assign a value to the target variable; displaying action configuration information corresponding to the target variable, in an action configuration page corresponding to a target action event, in response to a third trigger operation on the target action event; switching from the action configuration page to display the application editing page based on the value being assigned to the target variable, wherein the value is assigned based on the action configuration information; and rendering and displaying, in the application editing page in response to a fourth trigger operation on a running component in the application editing page, the target variable to which the value has been assigned.

According to an aspect of the disclosure, a page processing apparatus includes, at least one memory configured to store computer program code; and at least one processor configured to read the program code and operate as instructed by the program code, the program code including page display code configured to cause at least one of the at least one processor to display an application editing page, and display, in response to a first trigger operation on a variable creation component in the application editing page, a variable creation page corresponding to a variable type indicated by the variable creation component; variable display code configured to cause at least one of the at least one processor to display, in response to a variable definition operation triggered on the variable creation page, a target variable corresponding to the variable type in the variable creation page; first action configuration code configured to cause at least one of the at least one processor to display, in response to a second trigger operation on an action adding component in the application editing page, an action event configuration page corresponding to the action adding component, the action event configuration page including at least one action event configured to assign a value to the target variable; second action configuration code configured to cause at least one of the at least one processor to display action configuration information corresponding to the target variable, in an action configuration page corresponding to a target action event, in response to a third trigger operation on the target action event; switching display code configured to cause at least one of the at least one processor to switch from the action configuration page to display the application editing page based on the value being assigned to the target variable, wherein the value is assigned based on the action configuration information; and a rendering display code configured to cause at least one of the at least one processor to render and display, in the application editing page in response to a fourth trigger operation on a running component in the application editing page, the target variable to which the value has been assigned.

According to an aspect of the disclosure, a non-transitory computer-readable storage medium, storing computer code which, when executed by at least one processor, causes the at least one processor to at least display an application editing page, and display, in response to a first trigger operation on a variable creation component in the application editing page, a variable creation page corresponding to a variable type indicated by the variable creation component; display, in response to a variable definition operation triggered on the variable creation page, a target variable corresponding to the variable type in the variable creation page; display, in response to a second trigger operation on an action adding component in the application editing page, an action event configuration page corresponding to the action adding component, the action event configuration page including at least one action event configured to assign a value to the target variable; display action configuration information corresponding to the target variable, in an action configuration page corresponding to a target action event, in response to a third trigger operation on the target action event; switch from the action configuration page to display the application editing page based on the value being assigned to the target variable, wherein the value is assigned based on the action configuration information; and render and display, in the application editing page in response to a fourth trigger operation on a running component in the application editing page, the target variable to which the value has been assigned.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic flowchart of a page processing solution according to some embodiments;

FIG. 2 is a schematic architectural diagram of a page processing system according to some embodiments;

FIG. 3 is a schematic diagram of a data flow direction of page processing according to some embodiments;

FIG. 4 is a schematic flowchart of a page processing method according to some embodiments;

FIG. 5 is a schematic diagram of an application editing page according to some embodiments;

FIG. 6 is a schematic diagram of displaying a variable creation component according to some embodiments;

FIG. 7 is another schematic diagram of displaying a variable creation component according to some embodiments;

FIG. 8 is still another schematic diagram of displaying a variable creation component according to some embodiments;

FIG. 9 is still another schematic diagram of displaying a variable creation component according to some embodiments;

FIG. 10 is a schematic diagram of displaying a variable creation page according to some embodiments;

FIG. 11 is a schematic diagram of displaying a target variable in a variable creation page according to some embodiments;

FIG. 12 is a schematic diagram of displaying a global variable type according to some embodiments;

FIG. 13 is a schematic diagram of entering variable identification information according to some embodiments;

FIG. 14 is a schematic diagram of determining a data type according to some embodiments;

FIG. 15 is a schematic diagram of displaying a determined data type according to some embodiments;

FIG. 16 is a schematic diagram of displaying a target variable structure of a target variable according to some embodiments;

FIG. 17 is a schematic diagram of determining a target variable structure of a target variable according to some embodiments;

FIG. 18 is a schematic diagram of displaying one or more variable structures according to some embodiments;

FIG. 19 is a schematic diagram of displaying a to-be-modified target variable according to some embodiments;

FIG. 20 is a schematic diagram of modifying a target variable according to some embodiments;

FIG. 21 is a schematic diagram of entering an action event configuration page according to some embodiments;

FIG. 22 is a schematic diagram of an interface calling event for variable value assignment according to some embodiments;

FIG. 23 is a schematic diagram of action configuration information corresponding to a target variable according to some embodiments;

FIG. 24 is a schematic diagram of submitting a form event for variable value assignment according to some embodiments;

FIG. 25 is a schematic diagram of selecting a form target according to some embodiments;

FIG. 26 is a schematic diagram of selecting a target variable to which a value is to be assigned according to some embodiments;

FIG. 27 is a schematic diagram of assigning a value to a variable in a variable value assignment event according to some embodiments;

FIG. 28 is a schematic diagram of selecting a target variable to which a value is to be assigned according to some embodiments;

FIG. 29 is another schematic diagram of selecting a target variable to which a value is to be assigned according to some embodiments;

FIG. 30 is a schematic diagram of entering an expression setting page according to some embodiments;

FIG. 31 is a schematic diagram of selecting a parameter according to some embodiments;

FIG. 32 is a schematic diagram of displaying a selected parameter in an action configuration page according to some embodiments;

FIG. 33 is a schematic flowchart of a page processing method according to some embodiments;

FIG. 34 is a schematic diagram of creating an application page according to some embodiments;

FIG. 35 is a schematic diagram of a page component included in an application page according to some embodiments;

FIG. 36 is a schematic diagram of displaying a variable usage option corresponding to a target page component according to some embodiments;

FIG. 37 is a schematic diagram of entering a variable usage page according to some embodiments;

FIG. 38 is a schematic diagram of triggering an application page run by a running component according to some embodiments;

FIG. 39 is a schematic flowchart of a page processing method according to some embodiments;

FIG. 40 is a schematic diagram of displaying an input parameter setting option corresponding to a target page component according to some embodiments;

FIG. 41 is a schematic diagram of entering an input parameter setting page according to some embodiments;

FIG. 42 is a schematic diagram of setting an input parameter according to some embodiments;

FIG. 43 is a schematic diagram of displaying a variable used as an input parameter according to some embodiments;

FIG. 44 is a schematic structural diagram of a page processing apparatus according to some embodiments; and

FIG. 45 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Related terminologies in some embodiments are described below.

### 1. Application Orchestration

Application orchestration can define data and application services and can quickly create and deploy applications. Application orchestration can include two states: a design state and a running state. The design state can be understood as a visual simulation of traditional coding. Any user (such as operators and application designers) can create an application page for an application in a visual manner in the design state. In the design state, a page component of a page can be designed, an interactive behavior (for example, when clicking on a view button on a page to jump to a view page, jumping to the view page is an interactive behavior) of a page component (such as buttons, options, and tables) in an application page is set, a variable is declared, a variable value is assigned to the declared variable to save corresponding data, a variable to be used is bound for the application page, or the like.

The running state refers to triggering the running component to produce final running code of an entire application page, and running the code to display the effect of the entire application page. When an application page is in the running state, an interactive behavior in the application page can be responded to, a variable value is assigned to a declared variable on the application page, the variable to which a variable value has been assigned is rendered and displayed, and the like.

### 2. Action Event

An action event refers to a behavior of completing an operation, and the behavior can be a behavior of the smallest granularity, such as: message prompt, pop-up confirmation, interface calling, logging in, submitting a form, opening an application page, closing an application page, and opening a link. In some embodiments, a variable value can be assigned to a defined variable through an action event.

### 3. Variable

As the name suggests, a variable is a number whose value can change. In some embodiments, variables can be used as data carriers and as sources of rendering. Based on function scopes of variables, variables can be divided into: global variables, page variables, and input parameter variables. The global variables refer to variables that are valid throughout the application life cycle, and each application page can be used to freely assign values to and use the variables. Two global variables with the same identification cannot be defined in one application. Page variables refer to variables that are only used in an application page of an application, for example, only the application page can be used to assign values to and use variables on the page. Besides, two variables with the same identification cannot be defined in the same application page. Input parameter variables refer to variables that are only used to parse and request a query parameter of a current application page. For example, a variable value of an input parameter variable refers to a parameter carried after the question mark of an access address when accessing a page. For example, if the access address is “http://dhdhdh?uid”, the variable value of the input parameter variable is uid (for example, a user identification). The input parameter variable is only valid in the current application page.

Some embodiments provide a page processing solution. The page processing solution can provide a visual application platform, and application orchestration can be performed on the visual application platform. For example, an application page can be created on the visual application platform, and in an application editing page of the visual application platform, a variable is defined for the application page, a variable value is assigned to the defined variable (hereinafter referred to as a target variable), the variable to which a variable value has been assigned is used, and the like. The reason why the visual application platform in some embodiments provides a mechanism for visually creating variables, assigning values, and using variables is as follows: First of all, the visual application platform can be oriented to non-program developers (such as product managers and operation personnel). Secondly, to visually simulate a traditional manner of writing application page logic, there may be four capabilities: page display, response interaction, logic control, and data source. To fully implement this logic control, variables may be visually used as data carriers and as the source of rendering.

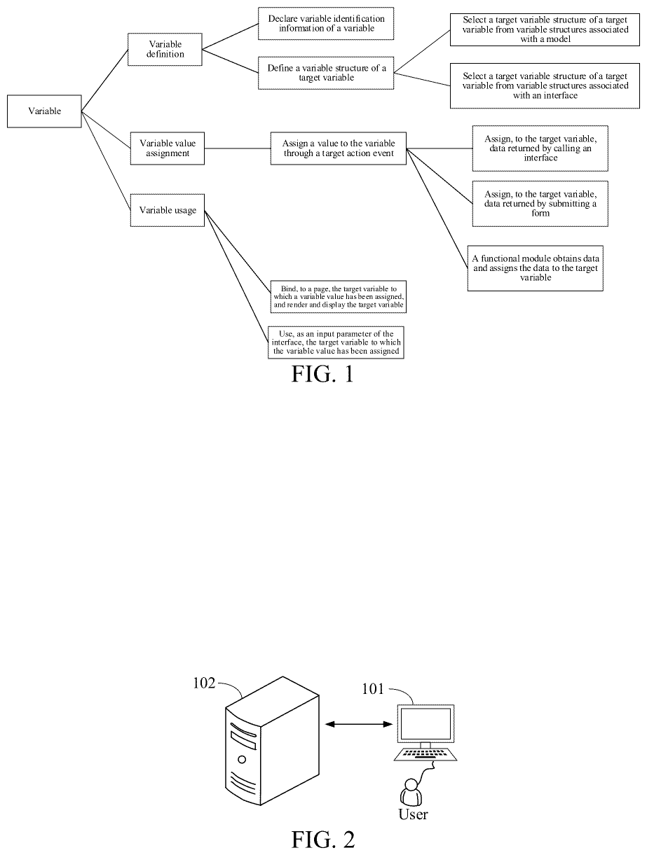

Referring to FIG. 1, a page processing solution provided by some embodiments is described from the aspects of variable definition, variable value assignment, and variable usage:

\textcircled{1} Variable definition: An application editing page is displayed on the visual application platform. Any user (operators, program developers, product managers, or the like) can trigger (such as click, long press, or slide) a variable creation component in the application editing page, and in response to a trigger operation on the variable creation component in the application editing page, a variable creation page corresponding to a variable type indicated by the variable creation component is displayed. Then, when a user defines a variable in the variable creation page, in response to a variable definition operation on a variable type triggered in the variable creation page, the variable to be defined is declared in the variable creation page (for example, variable identification information of the variable is declared). After declaring the variable, if a variable structure of the declared variable may be defined (in some embodiments, the defined variable is referred to as the target variable), a variable structure can be selected as the variable structure of the target variable from a variable structure associated with a model or a variable structure associated with an interface. In this way, it is created that the variable type corresponds to the target variable, and the target variable corresponding to the variable type is displayed in the variable creation page.

The process of declaring a variable can be regarded as defining a variable or creating a variable.

\textcircled{2} Variable value assignment: After creating the target variable, the target variable may be allowed to use anywhere in the application page. The target variable may be parsed to perform visual value assignment and visual usage. A variable value has been assigned to the target variable. In some embodiments, a variable value can be assigned to the target variable through an action event. For example, if the action event is to call an interface, a data variable returned from the interface can be assigned to the target variable. For another example, if the action event is to submit a form, a data variable returned when submitting the form can be assigned to the target variable.

The variable value assignment of the target variable in some embodiments is not limited to the above two manners. For example, a data variable returned by a component method can be assigned to the target variable or a data variable returned by a functional module can be assigned to the target variable.

In some embodiments, an action event configuration page corresponding to an action adding component may be displayed in response to a trigger operation on the action adding component in the application editing page, the action event configuration page including at least one action event configured to assign a value to the target variable. Then, a user can select a target action event from the at least one action event. In response to a trigger operation on the target action event of the at least one action event, action configuration information corresponding to the target variable is displayed in an action configuration page corresponding to the target action event. Displayed action configuration information corresponding to the target variable is to implement variable value assignment of the target variable.

\textcircled{3} Variable usage: After completing the variable value assignment of the target variable, the target variable to which a value has been assigned can be used as the source of variable value assignment for other variables (for example, variable value assignment for the second time), or the target variable to which a value has been assigned can be bound to the application page, or the variable value of the target variable to which a value has been assigned is used as an input parameter of an interface. Then, the target variable to which the value has been assigned may be rendered and displayed in the application editing page of a visual platform in response to a trigger operation on a running component in the application editing page. In some embodiments, when the target variable to which a value has been assigned is bound to the application page, the target variable to which a value has been assigned can be rendered and displayed in the application page. In some embodiments, when the variable value of the target variable to which the value has been assigned is transferred to the interface as the input parameter of the interface, the interface may be called to display an interface page of the interface.

The visual variable definition and variable usage provided by some embodiments implement the management of the entire life cycle of the variable. The visual platform provided by some embodiments can allow multiple users to collaboratively create a target application. Besides, each user can define variables for the application page of the target application, and the variables defined by each user can be displayed on an application editing page or a variable creation page. For example, the visual variable definition and variable usage can prevent the same variable from being created by multiple users at the same time, reduce redundancy variables to a certain extent, and improve collaboration efficiency when creating variables or applications.

It can be seen from the above solution: Some embodiments adopt a visual manner from variable definition to variable usage. Through the visual presentation, the technical complexity from variable definition to variable usage is reduced. In addition, it can also facilitate the management of defined variables, and variables on the current application page and information such as variable structures of the variables can be known clearly.

FIG. 2 is a schematic architectural diagram of a page processing system according to some embodiments. The page processing system includes a computer device 101 and a server 102. Some embodiments do not limit types and quantities of computer devices and servers.

The computer device 101 can provide a visual application platform. Applications can be orchestrated in the visual application platform, for example, users (such as operators and product managers) can create applications in the visual application platform, and create application pages, define variables, assign variable values to defined variables, use variables after variable value assignment, and the like in an application editing page in the visual application platform. In addition, the computer device 101 can store information about variables defined in the visual application platform, where the information includes at least one of the following: variable identification information, a data type, and a variable structure.

The computer device 101 may include but is not limited to: smartphones (such as Android phones and iOS phones), tablet computers, portable personal computers, mobile internet devices (MID), smart TVs, vehicle-mounted devices, head-mounted devices, intelligent voice interaction devices, aircrafts, and the like.

The server 102 may correspond to the computer device 101 and is a server that provides technical support for services provided by the computer device 101. For example, the computer device 101 provides an application orchestration service, and the server 102 is a server that provides technical support for the application orchestration service provided by the computer device 101. The server 102 may be configured to store information about defined variables. The server 102 may be an independent physical server, or may be a server cluster or a distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence platforms.

Application orchestration can be implemented in the visual application platform provided by the computer device 101. The computer device 101 can include the following modules: an application orchestration front-end storage, application orchestration page rendering, and an application orchestration front-end renderer. The server 102 may include: application orchestration back-end logic, an application orchestration cache (DB), and an application orchestration action execution engine.

The application orchestration front-end storage is configured to store data of the application orchestration front-end (for example, store information about variables defined in the visual application platform), for example, the application orchestration front-end storage is mainly configured to process data. In the application orchestration front-end storage, data can be stored using key-value, where the value can be an object, an array, or the like.

The application orchestration page rendering is mainly configured to render variable values of variables in the application page, and then display a page component of the application page or display a new page (such as an interface page), and the like.

The application orchestration front-end renderer refers to a bus designed to facilitate the parsing of variables, functions, expressions, calling methods, and the like. The data in the application orchestration front-end renderer is ultimately also stored in a memory. However, the difference from the storage is: the application orchestration front-end renderer is stored in a document object model (DOM) element. This renderer can only be used when the DOM is used. The application orchestration front-end renderer processes events, methods, variables, and actions related to the application page.

The application orchestration action execution engine is configured to execute action events related to the application page, for example, open the application page, close the application page, call the interface, and submit the form.

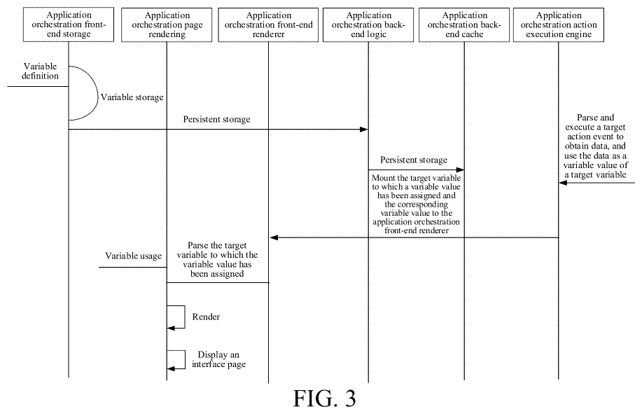

Based on the above page processing system, some embodiments provide a page processing process. A data flow direction of the page processing process can be shown in FIG. 3:

\textcircled{1} A user can create a target application on the visual application platform provided by the computer device 101, and enter relevant information such as an application name of the target application in the visual application platform. The target application can be an engineering service application (such as an application for collecting construction project information), a map application, a game application, a social application, and the like.

\textcircled{2} The user can trigger to enter an application editing page in the visual application platform, and create an application page of the target application in the application editing page. In some embodiments, the application editing page includes an application creation component, and the computer device 101 can display the application page of the target application in the application editing page in response to a trigger operation on the application creation component. The application page herein can be any page related to the target application. If the target application is a map application, the application page may be a page displaying a route and a surrounding environment of an area, or the application page may be a page for location search, or the like.

\textcircled{3} After creating the application page of the target application, variables corresponding to different variable types can be created for the application page. The variable types can include but are not limited to: a global variable type, an input parameter variable type, and a page variable type. For example, in some embodiments, variables corresponding to the global variable type, variables corresponding to the input parameter variable type, and variables corresponding to the page variable type can be created for the application page.

In some embodiments, the application editing page includes a variable creation component, and a user can trigger the variable creation component. In response to a trigger operation on the variable creation component, the computer device 101 displays a variable creation page corresponding to a variable type indicated by the variable creation component, and then creates, in the variable creation page, a target variable corresponding to the variable type indicated by the variable creation component.

The target variable that corresponds to the variable type indicated by the variable creation component and that is created in the variable creation page can include the following aspects: First, target identification information of the variable to be defined is entered in the variable creation page. Second, a target data type is selected in the variable creation page for the variable to be defined. The declaration of the variable to be defined can be completed. Third, when a variable structure may be defined for the defined target variable, a target variable structure can be determined for the defined variable from variable structures associated with variable structure sources such as a model or an interface.

In some embodiments, the variable to be defined may be called an initial variable, and the defined variable may be called a target variable.

After the target variable is created, the target variable has its own variable structure, and the target variable can only be executed in the running state and cannot be executed in the design state. In the design state, variables are declared and a process of assigning a variable value to the target variable through an action event is set. This process cannot be executed in the design state. A data protocol for defining variables may be used, and the target identification information, the variable type, and the target variable structure of the target variable are recorded through the data protocol. The data protocol is as follows:

```
  {
  id:string, //target identification information of the target variable
  method:‘ global’, // variable type global (global), system (system), state
(page variable), query (input parameter variable)
  type: “object”, // target data type
  value: “”, //default value
  dataSourceStruct: { //value assignment structure
      type: “api”, //api interface | mode model
      name: “identification information of interface or model”,
      selectedRowKeys: [“id”, “projectId”, “typeCode”, “typeName”,
      “parentCode”,
“route”] // select a structure field of a current model or interface
      struct: [
      {
      key: string, // root for now
      type: object, // variable structure corresponding to the model
      children: [{
        key: string, // English field name
        type: string, // type
        label: string, //Chinese field name
        description?: string, // field description
        uniqueKey?: boolean // is it a main key
      }]
    }], // variable structure that exists in variable structure sources such as
a current model or interface
  apiDataType: ‘response’, //response return parameter, request input
  parameter
  }
  }
```

In addition, since the functional scope of the target variable is divided into two types: a global type or a local type, in some embodiments, a variable that functions globally (for example, a global variable) can be stored in the key-value manner, where the key is the global type (for example, key is global), and value is the variable corresponding to the global type. A variable that functions locally (such as an input parameter variable and a page variable) can be stored in the key-value manner. In this case, key is a local type (the local type includes the input parameter variable type and the page variable type, for example, key is state), and value can be a variable corresponding to the input parameter variable type or a variable corresponding to the page variable type.

\textcircled{4} After the target variable is created (variable definition is completed), a variable value can be assigned to the target variable. The computer device 101 can assign a variable value to the target variable through the target event action. The target action event for variable value assignment of the target variable can be: variable value assignment events, interface calling events, form submission events, and the like. The action event can generate data. The data generated by the action event can be used as the variable value of the target variable, thereby completing the variable value assignment of the target variable.

\textcircled{5} After assigning a variable value to the target variable, the target variable to which the value has been assigned can be used. In some embodiments, the computer device 101 can bind the target variable to which a value has been assigned to the page component in the application page. The computer device 101 may use the variable value of the target variable to which a value has been assigned as an input parameter of an interface.

\textcircled{6} The computer device 101 can save the target variable and the information of the target variable in the application orchestration front-end storage. In addition, the application orchestration front-end storage can send the target variable and the information of the target variable to the application orchestration back-end logic, thereby persistently storing the target variable and the information of the target variable in the application orchestration back-end logic. At the same time, the application orchestration back-end logic can send the target variable and the information of the target variable to the application orchestration cache (DB) for persistent storage.

\textcircled{7} When the effect of the application page may be viewed, the running component in the visual application platform is triggered. The computer device 101 renders and displays, in the application editing page in response to a trigger operation on a running component in the application editing page, the target variable to which the value has been assigned.

When the target variable to which a value has been assigned is bound to a page component in the application page, the page component bound to the target variable to which the value has been assigned is rendered and displayed in the application editing page. When the variable value of the target variable to which a value has been assigned is used as an input parameter of an interface, the variable value of the target variable to which the variable value has been assigned is transferred to the interface as the input parameter of the interface, and an interface page of the interface is displayed.

When the running component in the application editing page is triggered, it means that the application page enters the running state. When the running component in the application editing page is not triggered, variable definition, variable value assignment of the variable through an action event, and the like in the visual application platform are all operations in the design state. For example, variable value assignment of the variable through an action event is not variable value assignment in the true sense.

The rendering and displaying, by the computer device in the application editing page in response to a trigger operation on a running component in the application editing page, the target variable to which the value has been assigned may include: in response to the trigger operation on the running component in the application editing page, the application orchestration action execution engine can parse the target action event and execute the target action event to obtain data generated by the target action event, and assign a generated data variable to the variable value of the target variable. Since variable value assignment is actually a behavior that occurs in the running state, the target variable to which a value has been assigned can be stored in the application orchestration front-end renderer, so that the target variable to which the value has been assigned can be parsed from the application orchestration front-end renderer when the target variable to which the value has been assigned is later used.

The application orchestration action execution engine can mount the target variable to which the value has been assigned and the corresponding variable value to the application front-end renderer. Then, when the application orchestration page rendering parses the target variable to which a value has been assigned, the application orchestration page rendering can search, from the application orchestration front-end renderer, for the variable value of the target variable to which a value has been assigned. If it is determined that the variable type of the target variable to which a value has been assigned is a global type, the variable value of the target variable to which a value has been assigned is searched from the application orchestration front-end renderer according to the global type and the target identification information (which is similar to global.a, where global represents the global type and a represents the target identification information) of the target variable to which a value has been assigned. If it is determined that the variable type of the target variable to which a value has been assigned is a page variable type, the variable value of the target variable to which a value has been assigned is searched from the application orchestration front-end renderer according to the page variable type and the target identification information (which is similar to state.b, where state represents the page variable type and a represents the target identification information) of the target variable to which a value has been assigned. Then, the variable value of the target variable to which a value has been assigned is rendered in the application page. If the variable value of the target variable to which a value has been assigned is used as an input parameter of an interface, the variable value of the target variable to which the variable value has been assigned is transferred to the interface as the input parameter of the interface, and an interface page of the interface is displayed.

The target application can include multiple application pages. When each application page is accessed, only the global variable, the page variable, and the input parameter variable defined by the currently accessed application page are mounted in the application orchestration front-end renderer.

It can be seen from the above solution: Some embodiments adopt a visual manner from variable definition to variable usage, for example, a variable is declared in a visual manner, then a variable value is assigned to the variable through an action event, finally the variable to which a variable value has been assigned is bound to a corresponding page component, and data can be automatically rendered when the running component is triggered. Visual presentation is used, reducing the technical complexity from variable definition to variable usage. In addition, it can also facilitate the management of defined variables, and variables on the current application page and information such as variable structures of the variables can be known clearly.

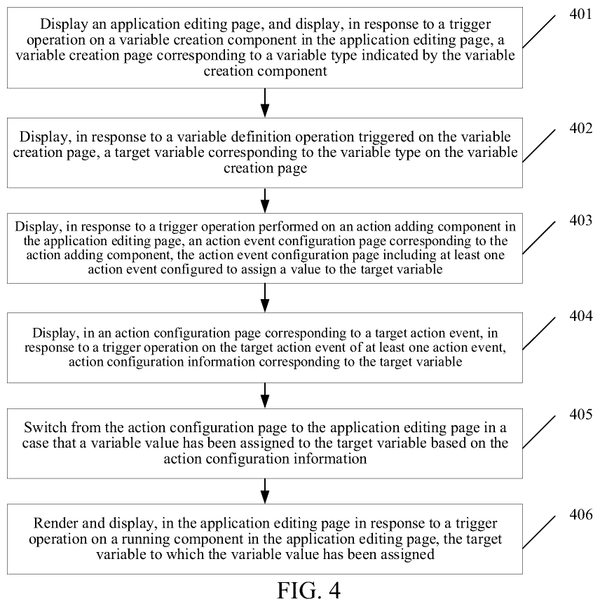

Based on the above related description, FIG. 4 is a schematic flowchart of a page processing method according to some embodiments. The page processing method can be performed by the computer device 101, and includes the following operation 401 to operation 406.

Operation 401: Display an application editing page, and display, in response to a trigger operation on a variable creation component in the application editing page, a variable creation page corresponding to a variable type indicated by the variable creation component.

The visual application platform can be the city digital space base (citybase) building block platform or other platforms that provide application orchestration. The trigger operation on the variable creation component in the application editing page can include but is not limited to: a click operation, a drag operation, a long press operation, and the like.

The variable creation component can include at least one of the following: a global variable component, an input parameter variable component, and a page variable component. The variable type includes: a global variable type corresponding to the global variable component (hereinafter referred to as a global variable), an input parameter variable type corresponding to the input parameter variable component (hereinafter referred to as an input parameter variable), and a page variable type corresponding to the page variable component (hereinafter referred to as a page variable).

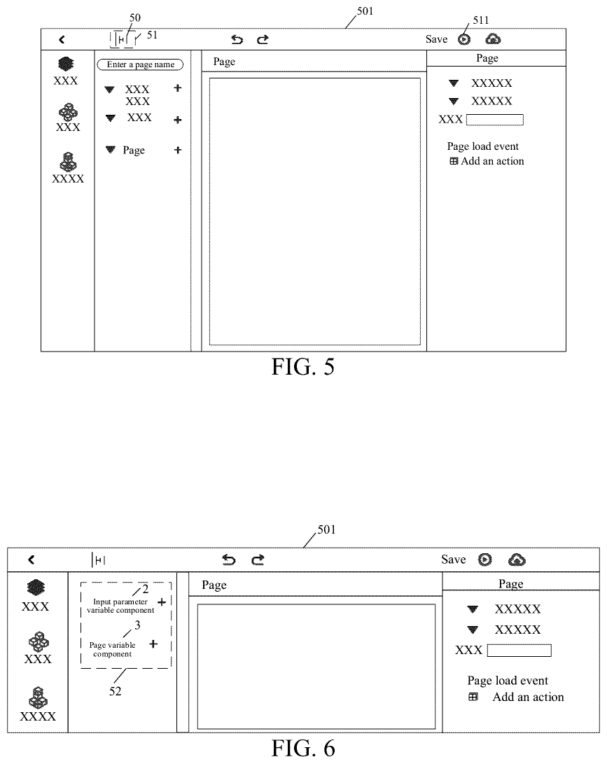

In some embodiments, the variable creation component can be displayed in a target display area of the application editing page, and the target display area can be any area in the application editing page. For example, as shown in FIG. 5, the target display area is an area 51 of the application editing page 501, for example, the variable creation component 50 can be displayed in the area 51. For another example, as shown in FIG. 6, the variable creation component includes an input parameter variable component 2 and a page variable component 3. The target display area may be an area 52 of the application editing page 501, and the input parameter variable component 2 and the page variable component 3 may be displayed in the area 52. The target display area may also be a lower right area, a right area, a left area, or the like of the application editing page, which is not limited.

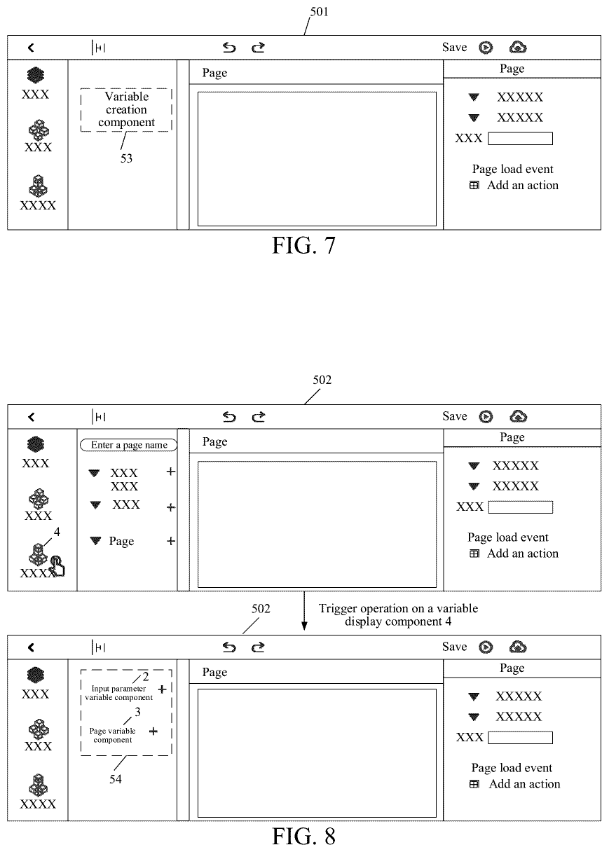

In some embodiments, the variable creation component can be displayed in a variable component page that is independent of the application editing page. A size of the variable component page is smaller than a size of the application editing page. For example, as shown in FIG. 7, the variable creation component is displayed in a variable component page 53 that is independent of the application editing page 501.

In some embodiments, the variable creation component is hidden in the application editing page, and in response to a variable creation component display operation on the application editing page, the hidden variable creation component is displayed in the application editing page. The variable creation component display operation can be a trigger operation (such as a click operation or a long press operation) on the page variable component in the application editing page. For example, as shown in FIG. 8, the variable creation component includes an input parameter variable component 2 and a page variable component 3. A user can trigger a variable display component 4 in the application editing page 502 (click on a page variable component 4 as shown in FIG. 8), and in response to the trigger operation on the variable display component 4, the input parameter variable component 2 and the page variable component 3 are displayed in an area 54 of the application editing page 502.

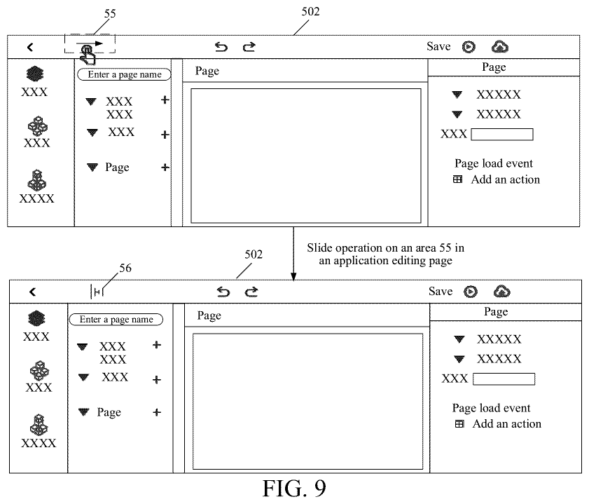

The variable creation component display operation can also be a sliding operation of sliding in a direction (such as leftwards, rightwards, or upwards) in a target area of the application editing page. For example, as shown in FIG. 9, the variable creation component display operation may be a sliding operation of sliding to the right in an area 55 of the application editing page 502. In response to the sliding operation on the area 55 of the application editing page 502, the variable creation component 56 is displayed in the application editing page 502. A display manner of the variable creation component is not limited in some embodiments.

When the variable creation component includes at least two of the global variable component, the input parameter variable component, the page variable component, and the system variable component, the at least two components included in the variable creation component can have different target display areas. For example, when the variable creation component includes the global variable component and the input parameter variable component, the target display area of the global variable component may be the area 51 shown in FIG. 5, and the target display area of the input parameter variable component may be the area 52 of the application editing page 501 shown in FIG. 6. In addition, the at least two components included in the variable creation component can also have the same target display area.

For example, when the variable creation component includes the page variable component and the input parameter variable component, the target display areas of the input parameter variable component and the page variable component are both the area 52 of the application editing page 501 shown in FIG. 6.

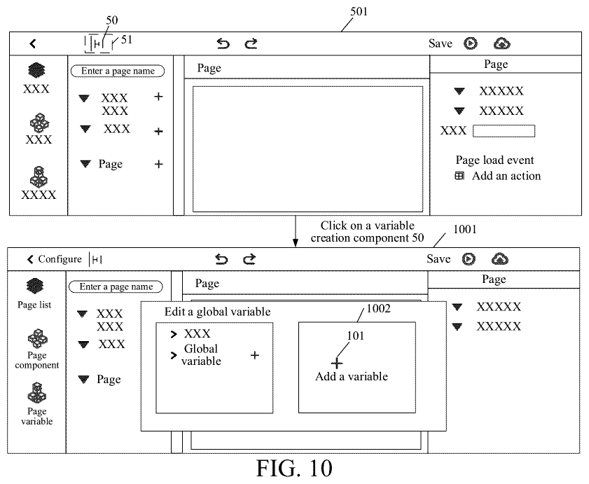

In some embodiments, for example, the variable creation component includes the global variable component, as shown in FIG. 10. The global variable component is a variable creation component 50 shown in FIG. 10. When a user triggers (such as clicks on) the variable creation component 50 in the application editing page 501, the computer device can display, in response to a trigger operation on the variable creation component 50 in the application editing page 501, a variable creation page 501 corresponding to a global variable type indicated by the variable creation component 50. Herein, only the example that the variable creation component includes the global variable component is used. When the variable creation component includes other variable components (for example, the input parameter variable component and the page variable component), a variable creation interface corresponding to a variable type indicated by another variable component is displayed with reference to displaying the variable creation page corresponding to the variable type indicated by the global variable component.

Operation 402: Display, in response to a variable definition operation triggered on the variable creation page, a target variable corresponding to the variable type in the variable creation page.

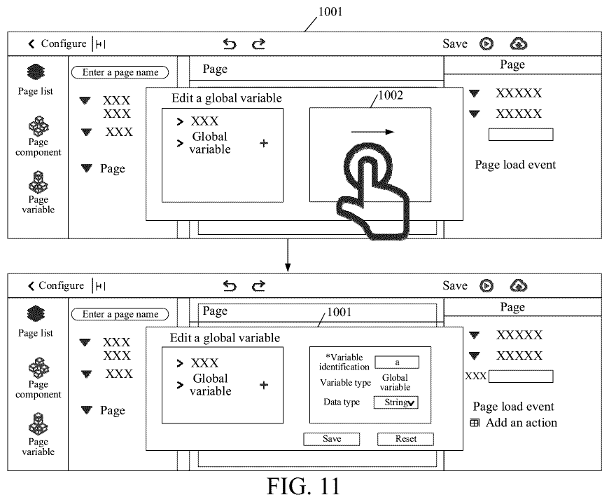

The variable definition operation may be a trigger operation on a variable definition area of the variable creation page. In some embodiments, the variable definition area includes a variable definition component corresponding to the variable type, and the trigger operation is a double-click operation, a single-click operation, a drag operation, or the like on the variable definition component. For example, as shown in FIG. 10, a variable definition area 1002 includes a variable definition component 101 corresponding to the variable type. The target variable corresponding to the variable type may be displayed in the variable creation page in response to a trigger operation on the variable definition component 101. In some embodiments, the variable definition operation may be a sliding operation of sliding in a target direction (such as rightwards or leftwards) in the variable definition area. For example, as shown in FIG. 11, the variable definition operation is a sliding operation of sliding on the right side in a variable definition area 1002. In response to the sliding operation of sliding on the right side in the variable definition area 1002, the target variable corresponding to the variable type is displayed in the variable creation page 1001, where the target variable has target identification information (for example, the target identification information is a), a variable type (for example, a global variable type), a target data type (for example, string), and the like. In some embodiments, the variable definition operation may be a click operation (such as a double-click operation or a single-click operation) on the variable definition area. The variable definition operation is not limited in some embodiments.

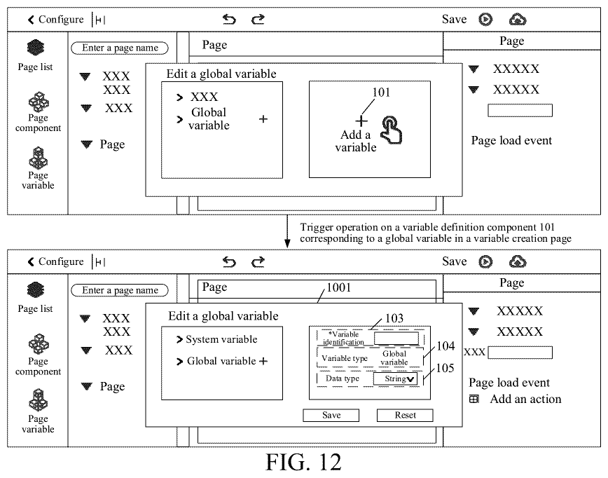

As shown in FIG. 12, the variable creation page 1001 may include a type display area 104 for displaying the variable type, a variable identification area 103 for entering variable identification information, and a data type area 105 for determining the data type. The displaying, in response to a variable definition operation triggered on the variable creation page, a target variable corresponding to the variable type in the variable creation page may include the following operation \textcircled{1} to operation \textcircled{5}

Operation \textcircled{1}: Display the variable type in a type display area of the variable creation page in response to a variable definition operation triggered on the variable creation page. The displayed variable type is the variable type of the initial variable. For ease of description, the example that the variable type is the global variable type is used below. For example, as shown in FIG. 12, when a user triggers the variable definition component 101 in the variable definition area of the variable creation page, in response to the trigger operation on the variable definition component 101 corresponding to the variable type (for example, a global variable) in the variable creation page, the global variable can be displayed in the type display area 104 of the variable creation page 1001.

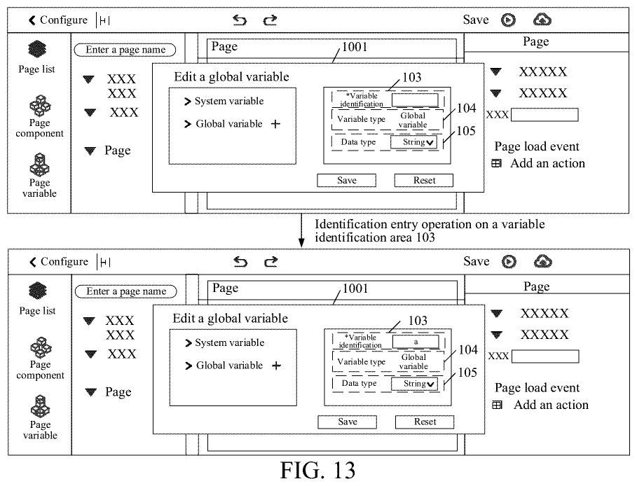

Operation \textcircled{2}: Display entered target identification information in a variable identification area in response to an identification entering operation on the variable identification area in the variable creation page, where the target identification information is variable identification information of the initial variable. For example, as shown in FIG. 13, the variable creation page 1001 may include a variable identification area 103. When the user wants to define the initial variable, the user may enter target identification information in the variable identification area 103. In this case, entered target identification information is displayed in the variable identification area 103 in response to an identification entering operation on the variable identification area 103 (for example, the target identification information is “a” shown in FIG. 13).

The entered target identification information can be displayed in a variable identification entering area of the variable identification area 103. Certainly, the variable identification entering area may be a circular area, a rectangular frame, an irregular quadrilateral, or the like, and the shape of the variable identification entering area is not limited.

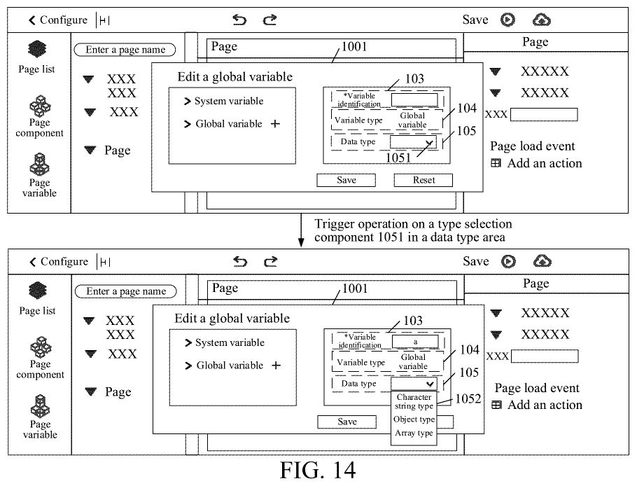

Operation \textcircled{3}: Output M candidate data types in response to a type trigger operation on a data type area in the variable creation page, where M is a positive integer. The candidate data types can be numeric types, character string types, array types, object types, and binary types. In some embodiments, the trigger operation can be a sliding operation, a click operation, or the like on the data type area. For example, the variable creation page 1001 includes a data type area 105, and a user can directly slide in the data type area 105 (for example, there is a sliding operation on the data type area 105). In response to the sliding operation on the data type area 105 of the variable creation page, the M candidate data types are outputted. In some embodiments, the type trigger operation may be a trigger operation on a type selection component in the data type area. The M candidate data types are outputted in response to a trigger operation on a type selection component 1051 in the data type area. For example, as shown in FIG. 14, the variable creation page 1001 includes a data type area 105. The data type area 105 includes a type selection component 1051, and the user can trigger the type selection component 1051. Correspondingly, in response to the trigger operation on the type selection component 1051 in the data type area, 3 candidate data types are outputted and are a character string type, an object type, and an array type respectively.

The output positions of the M candidate data types can be flexibly set. For example: the M candidate data types are outputted directly in the data type area 105. For another example, the M candidate data types can be outputted in a data type display page that is independent of the variable creation page. For another example, the M candidate data types are directly outputted in the variable creation page. For example, in FIG. 14, 3 candidate data types (for example, a character string type, an object type, and an array type) can be outputted in an area 1052. The output positions of the M candidate data types are not limited.

The output manners of the M candidate data types can also be set flexibly. For example, the output can be based on the usage frequency of the candidate data type, for example, as the usage frequency of the candidate data type is higher, the candidate data type is displayed in the first place. For example, in FIG. 14, the usage frequency of the character string type is greater than the usage frequency of the object type, and the usage frequency of the object type is greater than the usage frequency of the array type. As shown in FIG. 14, the character string type is ranked in the first place, the object type is ranked in the second place, and the array type is ranked in the third place. For another example, the M candidate data types can be directly outputted randomly.

Output positions, output manners, and the like of the M candidate data types can be flexibly set.

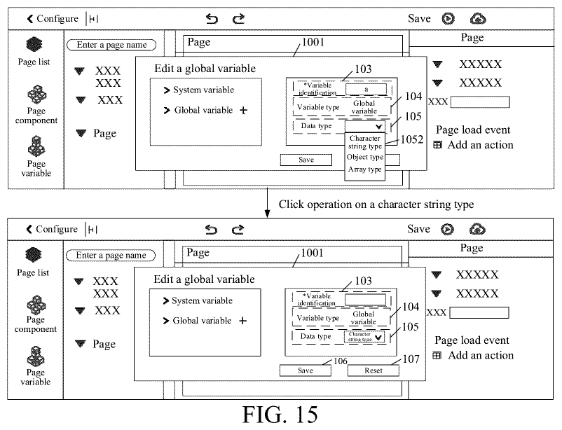

Operation \textcircled{4}: Display a target data type in the data type area in response to a type selection operation on the target data type of the M candidate data types, where the target data type is a data type of the initial variable. The type selection operation may be a click operation on the target data type of the M candidate data types. In response to the click operation on the target type data, the target data type is displayed in the data type area. For example, in FIG. 15, 3 candidate data types are respectively: a character string type, an object type, and an array type. When the user clicks on the character string type, the character string type is displayed in the data type area 105 in response to the click operation on the character string type. In some embodiments, the type selection operation can also be an operation of directly selecting, according to an order of the M candidate data types, a candidate data type that is ranked in the first place (for example, the target candidate data type). The target candidate data type ranked in the first place can be automatically displayed in the data type area. For example, M=3. The order of the 3 candidate data types is: a character string type, an object type, and an array type. The character string type is displayed in the first place, and the character string type is displayed in the data type area in response to a type selection operation on the character string type.

Operation \textcircled{5}: Use the initial variable having the target data type, the target identification information, and the variable type as the target variable, and display the target variable in the variable creation page. The target variable is a variable defined in the variable creation page. The target variable has a target data type, target identification information, and a variable type. For example, as shown in FIG. 15, the variable definition area of the variable creation page 101 displays a target variable that has target identification information a, a global variable type, and a character string type.

In some embodiments, the variable creation page 1001 further includes a confirmation component 106 and a reset component 107. In response to the trigger operation on the confirmation component 106, the variable creation page can be switched to display the application editing page. In response to the trigger operation on the reset component 107, the target variable in the variable creation page can be redefined.

When the data type of the target variable is a composite data type (such as an object type and an array type), the target variable structure of the target variable may be defined. In some embodiments, a target variable structure of the target variable is displayed in a variable structure editing page in response to a variable structure editing operation on the variable creation page. The variable structure editing page is switched to display the variable creation page in response to a confirmation operation on the target variable structure, and the target variable structure corresponding to the target variable is displayed in a variable structure display area of the variable creation page, where the target variable structure includes one or more target structure parameters. The variable structure editing operation can be: a trigger operation on the variable structure editing component in the variable creation page, or the variable structure editing operation can be a sliding operation, a click operation, or the like on the variable structure display area in the variable creation page. The confirmation operation can be a trigger operation (such as a single-click operation or a double-click operation) on the confirmation option in the variable structure editing page, or the confirmation operation can be an operation of sliding in the target direction in the variable structure editing page, or an operation of double clicking in any area in the variable structure editing page. The confirmation operation and the variable structure editing operation are not limited.

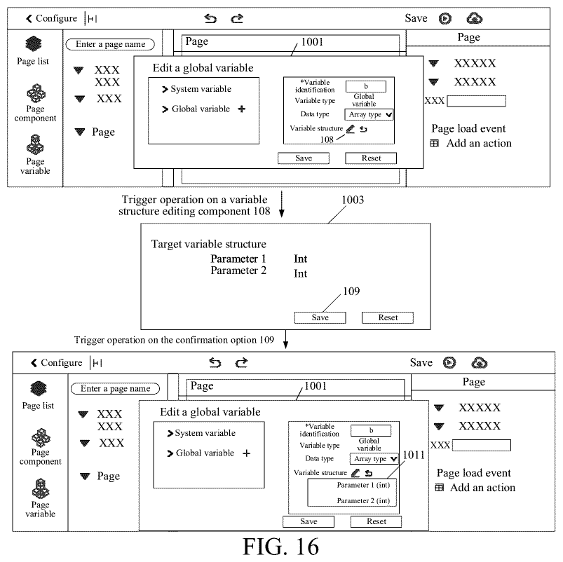

For example, as shown in FIG. 16, when the data type is an array type, the variable creation page 101 includes a variable structure editing component 108. In response to the trigger operation on the variable structure editing component 108, the target variable structure of the target variable is displayed in the variable structure editing page 1003. The target variable structure includes a structure parameter 1 and a structure parameter 2. The structure editing page 1003 further includes a confirmation option 109. When a user triggers the confirmation option 109, in response to the trigger operation on the confirmation option 109, the variable structure editing page 1003 can be switched to display the variable creation page 1001, and a variable structure display area 1011 of the variable creation page 1001 displays a target structure parameter (for example, the structure parameter 1 and the structure parameter 2) included in the target variable structure of the target variable.

In some embodiments, when the type selection operation is performed on the target data type of the M candidate data types and the target data type is displayed in the data type area, if the variable structure may be defined for the target variable in the target data type, the variable structure editing component 108 can be displayed together with the target data type. Certainly, the variable structure editing component can also always be displayed in the variable creation page. However, the disclosure is not limited thereto.

The displaying a target variable structure of the target variable in a variable structure editing page in response to a variable structure editing operation on the variable creation page may include but is not limited to the following manners:

(1) The displaying a target variable structure of the target variable in a variable structure editing page in response to a variable structure editing operation on the variable creation page may include: displaying the variable structure editing page in response to the variable structure editing operation on the variable creation page, where the variable structure editing page includes one or more variable structures, and one variable structure includes one or more structure parameters; and in a case that a target variable structure of the one or more variable structures is selected, displaying the target variable structure of the target variable in a variable structure display area of the variable structure editing page.

(2) The variable structure used by the variable can include a variable structure corresponding to a model (for example, some table structures), a variable structure corresponding to an interface, and the like. The variable structure corresponding to the interface can include an interface return parameter structure and an interface input parameter structure. In some embodiments, a model or an interface can be used as a variable structure source, so that a target variable structure can be quickly selected for the target variable from variable structure sources such as a model or an interface. The displaying a target variable structure of the target variable in a variable structure editing page in response to a variable structure editing operation on the variable creation page includes: displaying one or more variable structure sources in a variable structure source area of the variable structure editing page in response to the variable structure editing operation on the variable creation page; highlighting a target variable structure source of the one or more variable structure sources in the variable structure source area in response to a trigger operation on the target variable structure source; displaying, in response to a trigger operation on a variable structure identification area of the variable structure editing page, one or more variable structures associated with the target variable structure source; and in response to a trigger operation on the target variable structure of the one or more variable structures, displaying an identification of the target variable structure in the variable structure identification area, and displaying, in a variable structure content area of the variable structure editing page, a target structure parameter included in the target variable structure.

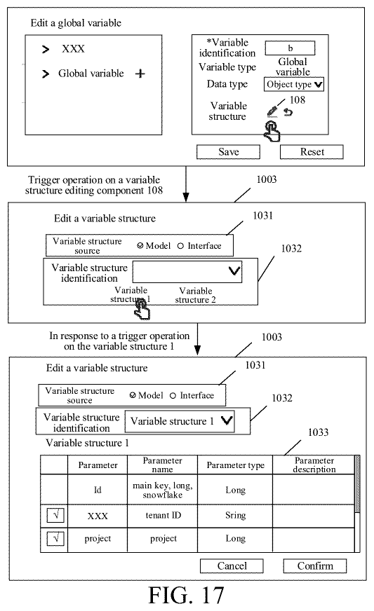

For example, as shown in FIG. 17, the data type is an object type. In response to a trigger operation on the variable structure editing component 108 in the variable creation page, a variable structure source area 1031 of the variable structure editing page 1003 displays two variable structure sources (for example, an interface and a model). When the user selects the target variable structure source (for example, a model), the variable structure source area displays the target variable structure source in a selected manner. One or more variable structures (a variable structure 1 and a variable structure 2 shown in FIG. 17) associated with the target variable structure source are displayed in response to a trigger operation on a variable structure identification area 1032 of the variable structure editing page. In response to a trigger operation on the variable structure 1 of the one or more variable structures, an identification of the variable structure 1 (for example, the variable structure 1) is displayed in the variable structure identification area 1032, and a structure parameter included in the variable structure 1 is displayed in a variable structure content area 1033 of the variable structure editing page. In some embodiments, the structure parameter included in the variable structure 1 can also be displayed in the variable structure content area 1033 of the variable structure editing page. In some embodiments, a parameter name, a parameter type, a parameter description, and the like of the structure parameter included in the variable structure 1 can also be displayed.

The highlight of the target variable structure source in the variable structure source area can be set flexibly. The target variable structure source is selected in the variable structure source area. For example, the target variable structure source is selected by “V” in the variable structure source area. For another example, the target variable structure source is displayed in bold in the variable structure source area. For another example, the target variable structure source is enlarged in the variable structure source area. The highlight of the target variable structure source is not limited in some embodiments.

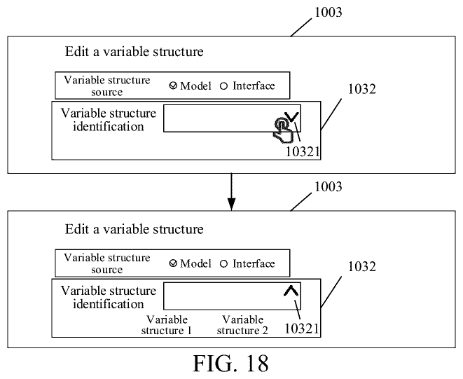

In some embodiments, when the variable structure identification area includes a variable structure selection component; the displaying, in response to a trigger operation on a variable structure identification area of the variable structure editing page, one or more variable structures associated with the target variable structure source may include: in response to a trigger operation (for example, the trigger operation can be a single-click, a double-click, a long press, and multiple clicks within a preset time) on the variable structure selection component, displaying one or more variable structures associated with the target variable structure source. For example, in FIG. 18, the variable structure identification area 1032 includes a variable structure selection component 10321. The variable structure selection component 10321 is clicked on. Correspondingly, in response to the click operation on the variable structure selection component, one or more variable structures associated with the model source are displayed, for example, two variable structures (for example, the variable structure 1 and the variable structure 2) associated with the model source are displayed in the variable structure identification area 1032.

One or more variable structures associated with the target variable structure source may be displayed in any position of the variable structure identification area. For example, any position may be a position shown in FIG. 18. One or more variable structures associated with the target variable structure source are displayed in a page independent of the variable structure editing page 1003. However, the disclosure is not limited thereto.

The target variable structure may include one or more candidate structure parameters, and the one or more candidate structure parameters may be directly used as the target structure parameter included in the target variable structure. In addition, a user can also select an appropriate candidate structure parameter as the target structure parameter of the target variable structure. The displaying, in a variable structure content area of the variable structure editing page, a parameter included in the target variable structure can include: in response to a selection operation on a candidate structure parameter in the target variable structure, highlighting, in the variable structure content area, the selected candidate structure parameter included in the target variable structure, and using the selected candidate structure parameter as the target structure parameter included in the target variable structure. For example, in FIG. 17, the candidate structure parameter included in the variable structure 1 (for example, the target variable structure) is identification (ID), XXX, and project. Then, in response to a selection operation on XXX and project, the selected XXX and project can be highlighted in the variable structure content area 1033 (for example, the selected candidate structure parameters are highlighted by “√”).

In some embodiments, the defined variable can also be modified. In response to a variable modification operation on the target variable, the to-be-modified target variable can be displayed in the variable modification area, and in response to a data modification operation on the to-be-modified target variable, the modified target variable can be displayed in the variable modification area.

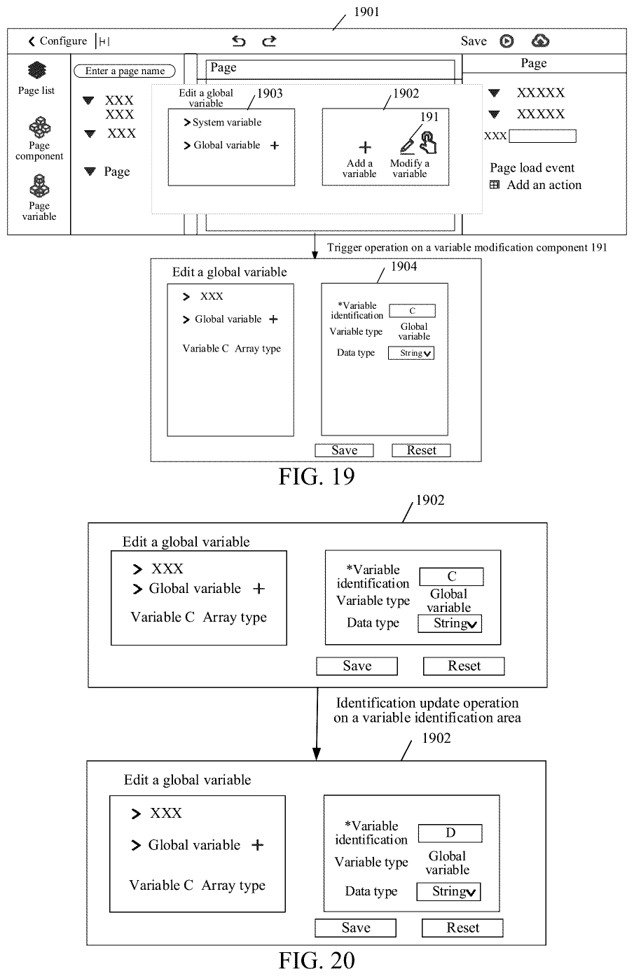

In some embodiments, the modification operation on the target variable may be a trigger operation on a variable modification component in the variable definition area. For example, as shown in FIG. 19, a variable definition area 1902 includes a variable modification component 191. In response to a trigger operation on the variable modification component 191, the to-be-modified target variable can be displayed in a variable modification area 1904. The variable modification area 1904 may display the target identification information of the to-be-modified target variable (for example, the target identification information is C). The variable type of the to-be-modified target variable is a global variable, and the target data type is string (for example, a character string type). In some embodiments, the variable creation page includes a variable display area 1903, and the variable display area 1903 displays the target variable, for example, (variable C, array type). The modification operation on the target variable can be directly triggering (such as clicking on or long pressing) the target variable.

The displaying the modified target variable in the variable modification area in response to the data modification operation on the to-be-modified target variable may include: updating the displayed entered target identification information in the variable identification area in response to an identification update operation on the variable identification area in the variable modification page, where the updated displayed target identification information is new variable identification information of the target variable; outputting M candidate data types in response to a type trigger operation on a data type area in the variable creation page; and updating a displayed target data type in the data type area in response to a type selection operation on the target data type of the M candidate data types, where the updated displayed target data type is used as a new data type of the target variable; and using a target variable having the new target data type, the new target identification information, and the variable type as the target variable, and displaying the target variable in the variable creation page. For example, as shown in FIG. 20, in response to the identification update operation on the variable identification area in the variable modification page, the displayed target identification information (for example, identification C) in the variable identification area is updated to identification D.

When the to-be-modified target variable is modified (for example, the to-be-modified target variable can be used as an initial variable), one or more of the target identification information, the target data type, and the target variable structure of the to-be-modified target variable can be modified. For implementation details of modifying the target identification information, the target data type, and the target variable structure of the to-be-modified target variable, refer to the descriptions of defining the initial variable.

Operation 403: Display, in response to a trigger operation on an action adding component in the application editing page, an action event configuration page corresponding to the action adding component, the action event configuration page including at least one action event configured to assign a value to the target variable.

The action event for variable value assignment of the target variable may be an interface calling event, a form submission event, a variable value assignment event, and the like. The interface calling event is an event that calls an interface. When an interface (for example, the target interface) is called, corresponding data is returned. The data returned by the target interface can be assigned to the target variable as a variable value. The form submission event is an event of submitting a form (for example, the target form). When the target form is submitted, corresponding data is returned. The data returned by submitting the target form can also be assigned to the target variable as a variable value. The variable value assignment event may be directly assigning a variable value to a target. Directly assigning a variable value herein can include: The variable value of the variable to which a variable value has been assigned is directly assigned to the target variable, data opened by a component method is directly assigned to the target variable, and data opened by a module parameter (or a module function) is directly assigned to the target variable.

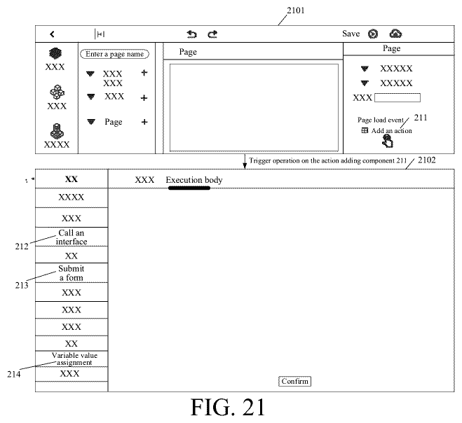

The trigger operation on the action adding component in the application editing page can be a click operation, a long press operation, a sliding operation of sliding in a direction, and the like. When a variable value may be assigned to a defined variable (for example, the target variable), the action adding component is included in the application editing page, and the action adding component is triggered to enter the action event configuration page to assign a variable value to the target variable. For example, as shown in FIG. 21, an application editing page 2101 includes an action adding component 211. In response to a trigger operation (for example, a click operation) on the action adding component 211, an action event configuration page 2102 corresponding to the action adding component is displayed. The action event configuration page 2102 includes 3 action events (an interface calling event 212, a form submission event 213, and a variable value assignment event 214) for variable value assignment of the target variable.

Operation 404: Display, in an action configuration page corresponding to a target action event, in response to a trigger operation on the target action event of at least one action event, action configuration information corresponding to the target variable.

The target action event is any action event of at least one action event. The trigger operation can be a click operation, a long press operation, a sliding operation of sliding in a direction, and the like.

In some embodiments, when the target action event is an interface calling event, the displaying, in an action configuration page corresponding to the target action event in response to a trigger operation on the target action event of at least one action event, action configuration information corresponding to the target variable may include operations 11 to 15:

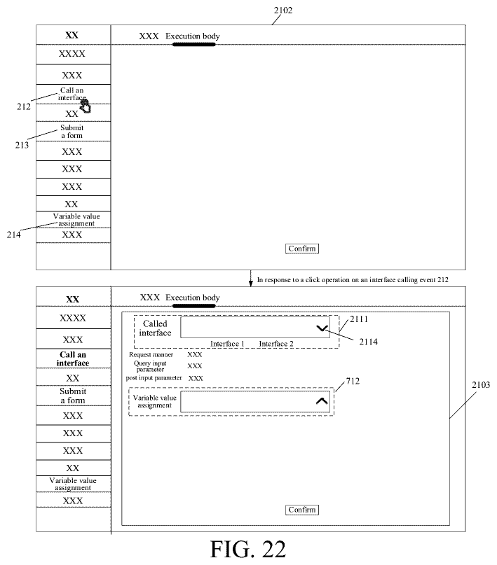

11: Display, in response to a trigger operation (for example, the trigger operation can be a single click, a double click, long press, and multiple clicks within a preset time) on the interface calling event of the at least one action event, an action configuration page corresponding to the interface calling event, where the action configuration page may include an interface calling display area and a first variable value assignment area, the interface calling display area is used to display interface information, and the first variable value assignment area is used to display the target variable to which a value is to be assigned. For example, as shown in FIG. 22, a user clicks on an interface calling event 212 of at least one action event. In response to the click operation on the interface calling event 212 of the at least one action event, an action configuration page 2103 corresponding to the interface calling event is displayed. The action configuration page 2103 includes an interface calling display area 2111 and a first variable value assignment area 2112.

12: Display one or more interfaces in response to an interface selection operation in the interface calling display area. The interface selection operation may be a trigger operation on the interface selection component in the interface display area, or the interface selection operation may be a click operation, a sliding operation, or the like on the interface display area.

The interface selection operation is not limited. For example, as shown in FIG. 22, the interface display area 2111 includes an interface selection component 2114. In response to a trigger operation on the interface selection component 2114, one or more interfaces, for example, an interface 1 and an interface 2, may be displayed.

The display area of the one or more interfaces can be flexibly set. For example, the one or more interfaces may be displayed in any area of the interface calling display area 2111. For another example, the one or more interfaces can be displayed in the interface calling display page. For another example, the one or more interfaces can be displayed in any area of the action configuration page 2103.

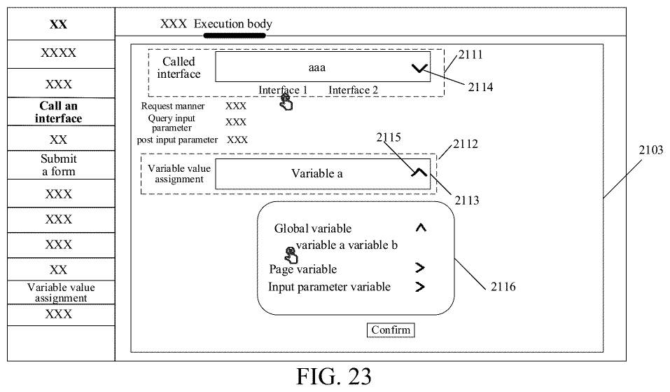

13: Display interface information of a target interface of the one or more interfaces in the interface calling display area in a case that the target interface is selected. For example, in FIG. 23, when the interface 1 is selected, interface information “aaa” of the interface 1 (for example, the target interface) is displayed in the interface calling display area 2111. The displaying the interface information of the target interface in the interface calling display area may include: displaying the target interface information in an interface display box in the interface calling display area.

14: Display a first variable list in response to a trigger operation in the first variable value assignment area, where the first variable list includes the target variable. The trigger operation on the first variable value assignment area may be performed on a value assignment variable selection component in the first variable value assignment area. For example, in FIG. 23, a first variable value assignment area 2112 includes a value assignment variable selection component 2115. In response to the trigger operation on the value assignment variable selection component 2115 in the first variable value assignment area, a first variable list 2116 is displayed. The first variable list 2116 may include defined variables (for example, in FIG. 23, the first variable list includes variables corresponding to the input parameter variable type, variables corresponding to the global variable type, and variables corresponding to the page variable type, and the target variable is any variable of the variable of the input parameter variable type, the variable of the global variable type, and the variable of the page variable type).

The displaying the first variable list may include but is not limited to: displaying the first variable list in any area of the action configuration page (for example, displaying the first variable list 2116 in the area shown in FIG. 23), displaying the first variable list in a variable value assignment selection page that is independent of the action configuration page, or the like.

15: Display, in the first variable value assignment area in a case that the target variable is selected, the target variable to which a value is to be assigned. The target variable to which a value is to be assigned can be displayed in the target display box in the first variable value assignment area. For example, in FIG. 23, when a variable a (for example, the target variable) is selected, the variable a can be displayed in the target display box 2113 in the first variable value assignment area 2112.

The displayed interface information of the target interface and the displayed target variable to which a value is to be assigned can both be understood as the action configuration information corresponding to the target variable. In response to the confirmation operation on the action configuration page, variable value assignment of the target variable can be completed based on the action configuration information. A variable value of the target variable to which a value has been assigned is data returned by calling the target interface. The confirmation operation herein may be a trigger operation on a confirmation component in the action configuration page, or the confirmation operation may be a sliding operation on any area of the action configuration page.

Operations 12 and 13 are performed after operations 14 and 15, and may also be performed before operations 14 and 15.

In some embodiments, when the target action event is a form submission event, the displaying, in an action configuration page corresponding to the form submission event in response to a trigger operation on the form submission event of at least one action event, action configuration information corresponding to the target variable may include operations s21 to s25:

s21: Display, in response to a trigger operation (for example, the trigger operation can be a single click, a double click, long press, and multiple clicks within a preset time) on the form submission event of the at least one action event, an action configuration page corresponding to the form submission event, where the action configuration page may include a form information display area and a second variable value assignment area. The form information display area is used to display form information, and the second variable value assignment area is used to display the target variable to which a value is to be assigned.

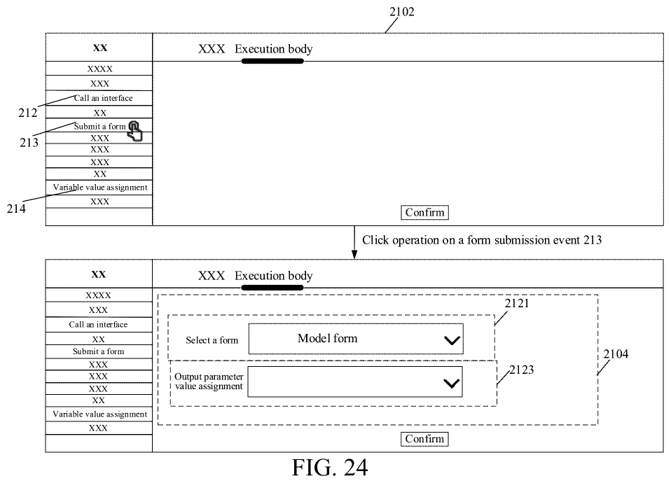

For example, as shown in FIG. 24, a user clicks on a form submission event 213 of at least one action event. In response to the click operation on the form submission event 213 of the at least one action event, an action configuration page 2104 corresponding to the form submission event is displayed. The action configuration page 2104 includes a form information display area 2121 and a second variable value assignment area 2123.

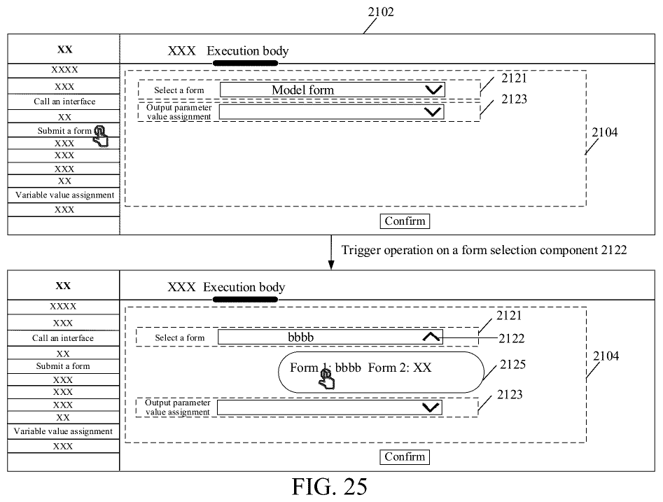

s22: Display form information of one or more forms in response to a form selection operation in the form information display area. The form selection operation may be a trigger operation on the form selection component in the form information display area, or the form selection operation may be a click operation, a sliding operation, or the like on the form information display area. The form selection operation is not limited. For example, as shown in FIG. 25, a form information display area 2121 includes a form selection component 2122. In response to the trigger operation on the form selection component 2122, form information of one or more forms (for example, form information “bbbb” of a form 1 and form information “XX” of a form 2) may be displayed.

The form information for displaying one or more forms may include but is not limited to: The form information of the one or more forms can be displayed in any area of the action configuration page 2104 or can be displayed in a page that is independent of the action configuration page 2104. For example, an area 2125 of the action configuration page 2104 displays the form information of the form 1 and the form information of the form 2. Certainly, the any area may be the middle area or the left area of the action configuration page 2104.

s23: Display form information of a target form of the form information of the one or more forms in the form information display area in a case that the form information of the target form is selected. For example, in FIG. 25, when the form information of the form 1 is selected, the form information “bbbb” of the form 1 is displayed in the form information display area.

As shown in FIG. 25, the form information of the target form can be displayed in a form information display box in the form information display area. The shape of the form information display box is not limited. For example, the shape of the form information display box may be a rectangle, a circle, or the like.

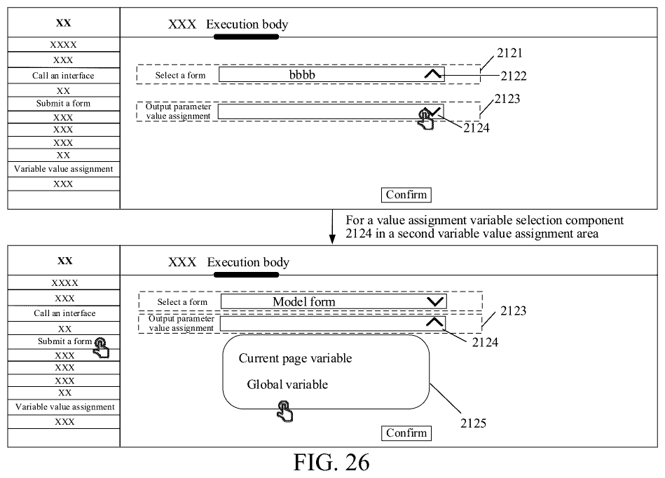

s24: Display a second variable list in response to a trigger operation in the second variable value assignment area, where the second variable list includes the target variable. The second variable list is displayed in response to the trigger operation in the second variable value assignment area, where the second variable list includes the target variable. The trigger operation on the second variable value assignment area may be performed on a value assignment variable selection component in the second variable value assignment area. For example, in FIG. 26, a second variable value assignment area 2123 includes a value assignment variable selection component 2124. In response to the trigger operation on the value assignment variable selection component 2124 in the second variable value assignment area, a second variable list 2125 is displayed. The second variable list 2125 may include the target variable. Certainly, the second variable list 2125 further includes defined variables (for example, in FIG. 26, the second variable list includes variables of the global variable type and variables of the page variable type, and the target variable is any one of the variables of the global variable type and the variables of the page variable type).

The displaying the second variable list may include but is not limited to: displaying the second variable list in any area of the action configuration page (for example, displaying the second variable list 2125 in the area shown in FIG. 26), displaying the second variable list in a variable value assignment selection page that is independent of the action configuration page, or the like.

s25: Display, in the second variable value assignment area in a case that the target variable is selected, the target variable to which a value is to be assigned. For example, in FIG. 26, when a global variable (for example, the target variable) is selected, the global variable may be displayed in the display box in the second variable value assignment area 2123. The shape of the display box is not limited.

The displayed form information of the target form and the displayed target variable to which a value is to be assigned can both be understood as the action configuration information corresponding to the target variable. In response to the confirmation operation on the action configuration page, variable value assignment of the target variable can be completed based on the action configuration information. A variable value of the target variable to which the value has been assigned is data returned when submitting the target form. The confirmation operation herein may be a trigger operation on a confirmation component in the action configuration page, or the confirmation operation may be a sliding operation on any area of the action configuration page.

In some embodiments, a value assignment action option of the target variable includes a variable value assignment event, and the displaying, in an action configuration page corresponding to the target action event in response to a trigger operation on the target action event of at least one action event, action configuration information corresponding to the target variable includes the following operations s31 to s36:

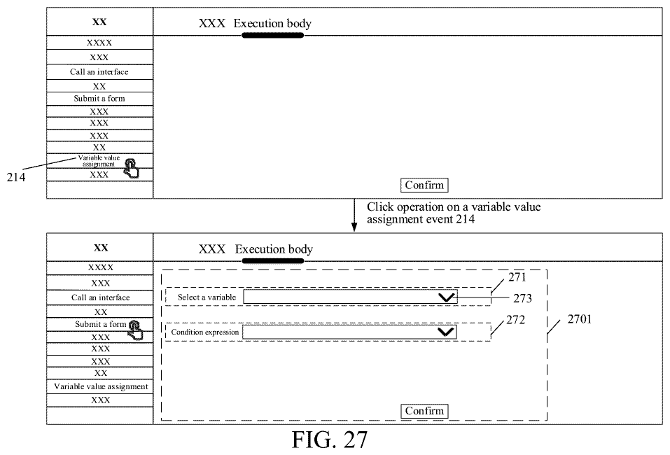

s31: Display, in response to a trigger operation on a variable value assignment event of the at least one action event, an action configuration page corresponding to the variable value assignment event. The trigger operation herein can be a click operation, a long press operation, and the like. For example, as shown in FIG. 27, an action configuration page 2701 corresponding to the variable value assignment event is displayed in response to a click operation on a variable value assignment event 214 of the at least one action event. The action configuration page 2701 may include a variable selection area 271 and a parameter expression display area 272. The variable selection area 271 is used to display variables, and the parameter expression display area 272 is used to display parameters.

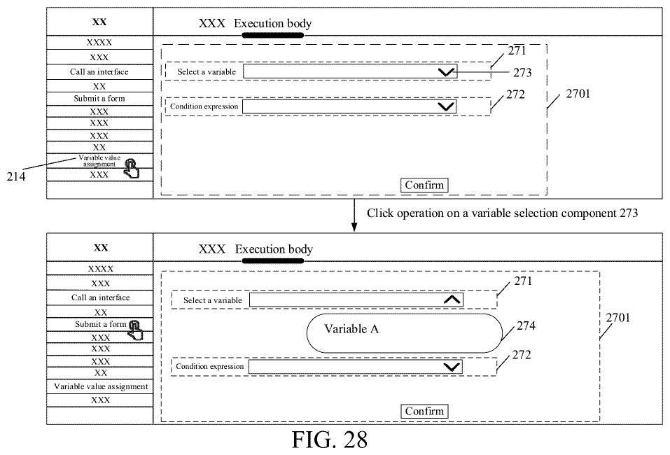

s32: Display, in response to a trigger operation on a variable selection area of the action configuration page, a third variable list to which a value is to be assigned, where the third variable list includes the target variable. The variable selection area 271 may include a variable selection component 273. The trigger operation on the variable selection area in the action configuration page may be a click operation, a long press operation, or the like on the variable selection component 273. For example, as shown in FIG. 28, when a user clicks on the variable selection component 273, the computer device may display a third variable list in response to the click operation on the variable selection component 273. The third variable list includes a variable A. The variable A is the target variable.

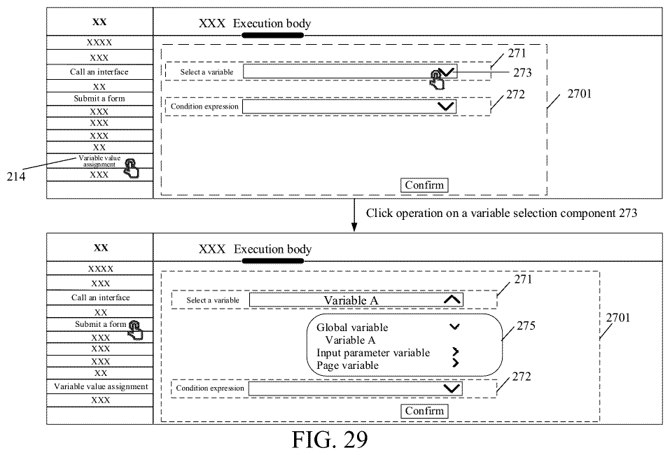

The third variable list may further include one or more of variables corresponding to the page variable type, variables corresponding to the global variable type, and variables corresponding to the input parameter variable type. The target variable is any variable of the variables corresponding to the page variable type, or the target variable is any variable of the variables corresponding to the global page type, or the target variable is any variable of the variables corresponding to the input parameter variable type. As shown in FIG. 29, when a user clicks on the variable selection component 273, the computer device may display a third variable list in response to the click operation on the variable selection component 273. The third variable list includes the variables corresponding to the page variable type, the variables corresponding to the global variable type, and the variables corresponding to the input parameter variable type. The variable corresponding to the global variable type includes the variable A (for example, the target variable).

In some embodiments, the third variable list to which a variable value is to be assigned can be displayed in the variable selection area of the action configuration page. For example, as shown in FIG. 28, the variable selection area 274 displays the third variable list to which a variable value is to be assigned. For another example, as shown in FIG. 29, a variable selection area 275 displays a third variable list to which a variable value is to be assigned. In some embodiments, a third variable list to which a variable value is to be assigned is displayed in a variable selection page that is independent of the action configuration page, or a third variable list to which a variable value is to be assigned is displayed in the variable selection area in a floating manner. How to display the third variable list to which a variable value is to be assigned is not limited.

s33: Display, in the variable selection area of the action configuration page in a case that the target variable is selected, the target variable to which a value is to be assigned. For example, as shown in FIG. 29, when the target variable (for example, a variable A in FIG. 29) is selected, the target variable (for example, the variable A in FIG. 29) to which a value is to be assigned is displayed in the variable selection area 271 of the action configuration page.

s34: Display an expression setting page in response to a trigger operation on a parameter display area of the action configuration page, where the expression setting page includes a first parameter list, the first parameter list includes one or more parameters, and the parameters include the variable to which a variable value has been assigned, a component method, an event parameter, and a constant.

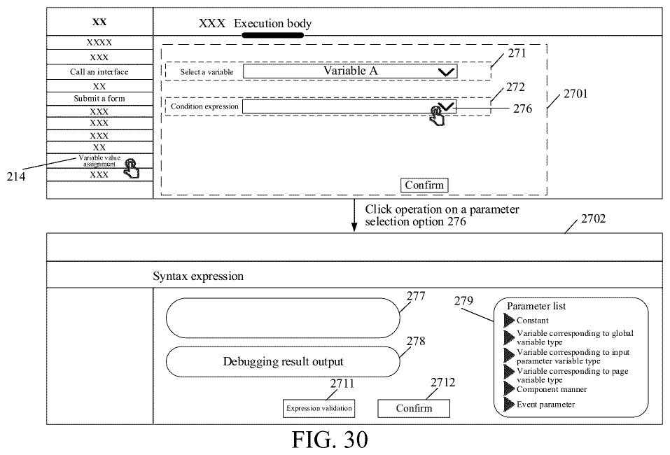

The trigger operation on the parameter display area in the action configuration page may be a click operation, a long press operation, or the like on the parameter selection option in the parameter display area. For example, in FIG. 30, a parameter display area 272 includes a parameter selection option 276. In response to a click operation on the parameter selection option 276, an expression setting page 2702 is displayed, and the expression setting page 2702 displays a parameter list 279. The parameter list 279 includes a variable to which a variable value has been assigned, a component method, an event parameter, and a constant. The variable to which a variable value has been assigned can include the variable to which a value has been assigned and that corresponds to the global variable type, the variable to which a value has been assigned and that corresponds to the page variable type, and the variable to which a value has been assigned and that corresponds to the input parameter variable type.

In some embodiments, the first parameter list can be displayed in any position of the expression setting page 2702. The any position can be, for example, a left area, a right area, an upper area, a middle area, or the like of the expression setting page 2702.

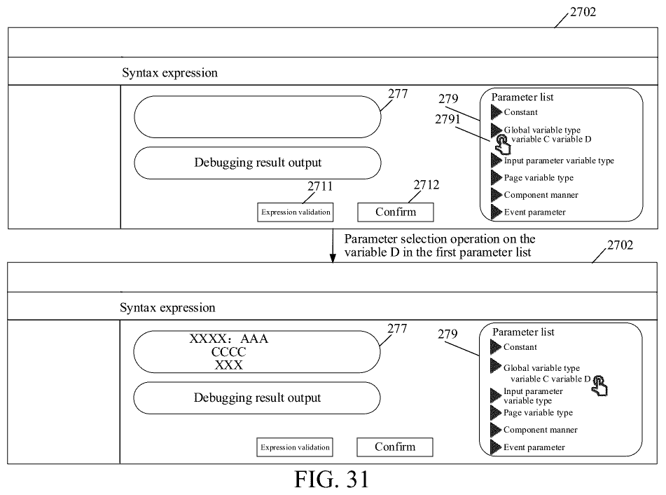

In some embodiments, as shown in FIG. 31, in response to a trigger operation on a selection component 2791 corresponding to the global variable type, the variable corresponding to the global variable type (for example, a variable C and a variable D shown in FIG. 31) can be displayed. In this case, both the variable C and the variable D are variables after variable value assignment.

Any parameter type corresponds to a selection component 2791. When the selection component is triggered, the variable corresponding to the parameter type can be displayed. For implementation details, refer to the descriptions of displaying the variable corresponding to the global variable type.

s35: Display, in an expression display area of the expression setting page in response to a parameter selection operation on a target parameter in the first parameter list, a target syntax expression corresponding to the target parameter. For example, in FIG. 31, in response to a parameter selection operation on the variable D (for example, a target parameter) in the first parameter list, a target syntax expression (for example, XXXX: AAA CCCC XXX) corresponding to the variable D is displayed in an expression display area 277 of the expression setting page. The target syntax expression herein can include: a parameter name, a parameter structure, a parameter value, or the like of the target parameter.

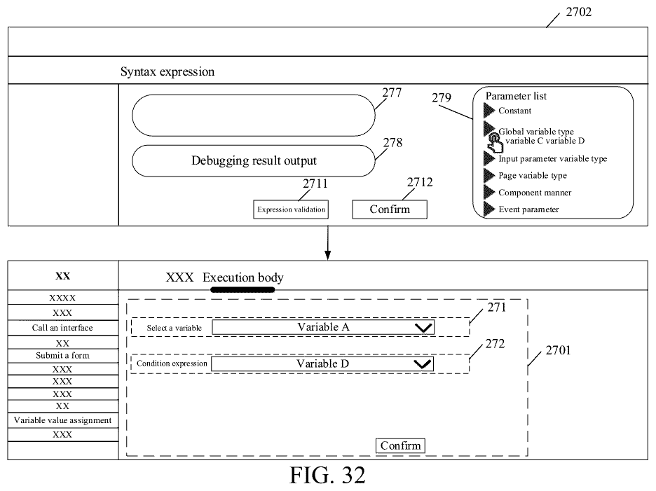

s36: Display the target parameter in a parameter display area of the action configuration page in a case that a confirmation option in the expression setting page is triggered, where a variable value of the target variable is a parameter value corresponding to the target parameter. For example, as shown in FIG. 32, the expression setting page includes an expression validation option 2711 and a confirmation option 2712. When the confirmation option 2712 in the expression setting page is triggered, the expression setting page is switched to display the action configuration page 2701, and the variable D is displayed in the parameter display area 272.

In some embodiments, the expression setting page includes an expression validation option 2711 for the target syntax expression. A debugging result of the target syntax expression is displayed in a debugging display area 278 of the expression setting page in a case that the expression validation option 2711 is triggered.

The selected target variable information and the target parameter displayed in the parameter display area of the action configuration page can be both understood as the action configuration information corresponding to the target variable. In response to the confirmation operation on the action configuration page, variable value assignment of the target variable can be completed based on the action configuration information. A variable value of the target variable to which the value has been assigned is a parameter value corresponding to the target parameter. The confirmation operation herein may be a trigger operation on a confirmation component in the action configuration page, or the confirmation operation may be a sliding operation on any area of the action configuration page.

Operation 405: Switch from the action configuration page to display the application editing page in a case that a value has been assigned to the target variable based on the action configuration information.

The action configuration page can be directly switched to display the application editing page in a case that a value has been assigned to the target variable based on the action configuration information. In some embodiments, the action configuration page includes a confirmation component, and the action configuration page is switched to display the application editing page in response to a trigger operation on the confirmation component in a case that a value has been assigned to the target variable based on the action configuration information.

Operation 406: Render and display, in the application editing page in response to a trigger operation on a running component in the application editing page, the target variable to which the value has been assigned.

In FIG. 5, the application editing page 501 may include a running component 511. The trigger operation on the running component in the application editing page may include but is not limited to a click operation, a long press operation, or the like on the running component 511.

The display position of the running component can be flexibly set. For example, the running component 511 can be displayed in the area shown in FIG. 5. For another example, the running component 511 may be displayed in a left area or a right area of the application editing page 501. For another example, the running component 511 can also be displayed in the application editing page 501 in a floating manner.

In some embodiments, an application editing page is displayed, and a variable creation page corresponding to a variable type indicated by a variable creation component is displayed in response to a trigger operation on the variable creation component in the application editing page. A target variable corresponding to the variable type is displayed in the variable creation page in response to a variable definition operation triggered on the variable creation page. An action event configuration page corresponding to the action adding component is displayed in response to a trigger operation on an action adding component in the application editing page, the action event configuration page including at least one action event configured to assign a value to the target variable. In response to a trigger operation on the target action event of at least one action event, action configuration information corresponding to the target variable is displayed in an action configuration page corresponding to a target action event. The action configuration page is switched to display the application editing page in a case that a value has been assigned to the target variable based on the action configuration information. The target variable to which the value has been assigned is rendered and displayed in the application editing page in response to a trigger operation on a running component in the application editing page. Visual presentation is used from variable definition to variable usage, thereby reducing the technical complexity from variable definition to variable usage.

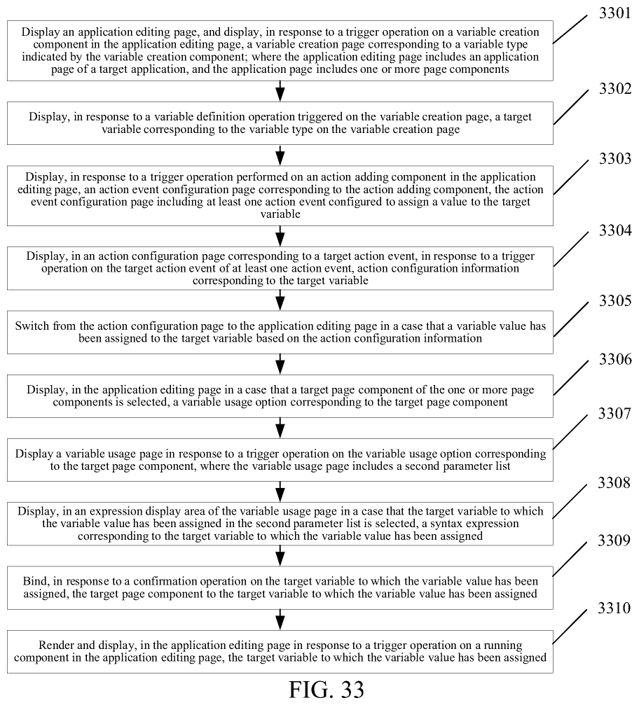

FIG. 33 is a schematic flowchart of a page processing method according to some embodiments. The page processing method can be performed by a computer device, and may include the following operation 3301 to operation 3310:

Operation 3301: Display an application editing page, and display, in response to a trigger operation on a variable creation component in the application editing page, a variable creation page corresponding to a variable type indicated by the variable creation component. The application editing page includes an application page of a target application, and the application page includes one or more page components.

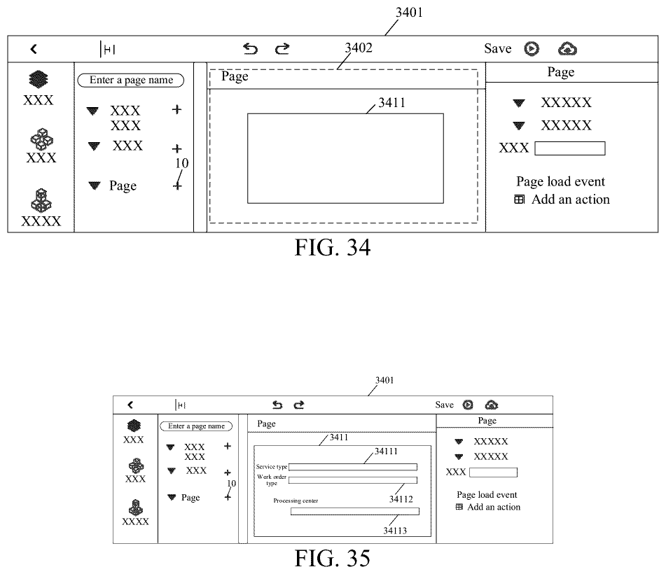

In some embodiments, the visual application platform includes an application creation component. An application name of a to-be-created target application is filled in the visual platform in response to a trigger operation on the application creation component in the visual application platform. The target application can be a gaming application, an engineering application, a traffic information collection application, and the like. An application editing page of the target application is displayed in the visual application platform in a case that an application editing component in the visual application platform is triggered. For example, as shown in FIG. 34, an application editing page 3401 of the target application may be displayed in the visual application platform in a case that the application editing component in the visual application platform is triggered.

In some embodiments, the application editing page 3401 includes a page creation component 10, and an application page of the target application can be created through the page creation component. In response to a trigger operation on the page creation component 10 (for example, the trigger operation may be a click operation or a long press operation), the application page of the target application is created, and the application page of the target application is displayed in the page display area of the application editing page 3401. The page display area can be any area in the application editing page. The page display area is a middle area, a left area, a right area, or the like of the application editing page. For example, in FIG. 34, an application page 3411 of a target application is displayed in a page display area 3402 of the application editing page 3401.

A user can design different page components in the application page of the target application. The page component herein can include but is not limited to: a table, a button, a form drop-down box, or the like. For example, as shown in FIG. 35, multiple page components may be displayed in the application page 3411 of the target application, for example, a page component 34111, a page component 34112, and a page component 34113.

After defining the target variable and assigning a value to the target variable, the application page of the target application can be created and the page component can be designed in the application page. Certainly, the application page of the target application can be created and the page component can be designed in the application page after creating the target application, and then the target variable is defined and a value has been assigned to the target variable. However, the disclosure is not limited thereto.

Operation 3302: Display, in response to a variable definition operation triggered on the variable creation page, a target variable corresponding to the variable type in the variable creation page.

Operation 3303: Display, in response to a trigger operation on an action adding component in the application editing page, an action event configuration page corresponding to the action adding component, the action event configuration page including at least one action event configured to assign a value to the target variable.

Operation 3304: Display, in an action configuration page corresponding to a target action event, in response to a trigger operation on the target action event of at least one action event, action configuration information corresponding to the target variable.

Operation 3305: Switch from the action configuration page to display the application editing page in a case that a value has been assigned to the target variable based on the action configuration information.

Operation 3306: Display, in the application editing page in a case that a target page component of the one or more page components is selected, a variable usage option corresponding to the target page component.

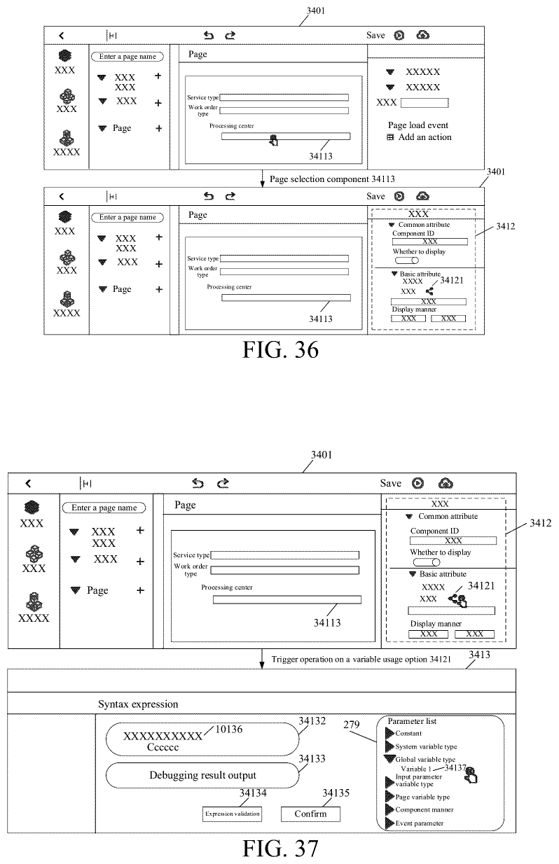

In some embodiments, a variable usage option corresponding to a target page component may be displayed in an attribute display area of the application editing page in a case that the target page component of the one or more page components is selected. The attribute display area can be any area of the application editing page. For example, as shown in FIG. 36, when the page component 34113 (for example, the target page component) is selected, a variable usage option 34121 corresponding to the page component 34113 can be displayed in an attribute display area 3412 of the application editing page 3401. The attribute information of the target page component, such as a component ID, whether to display, an attribute, and a display manner, can also be displayed in the attribute display area 3412. However, the disclosure is not limited thereto.

In some embodiments, when the target page component of the one or more page components is selected, the application editing page can be switched to display the attribute display page that is independent of the application editing page, and the variable usage option corresponding to the target page component can be displayed in the attribute display page.

Operation 3307: Display a variable usage page in response to a trigger operation on the variable usage option corresponding to the target page component, where the variable usage page includes a second parameter list, the second parameter list includes at least one parameter, and the parameter includes: the target variable to which the value has been assigned, a component method, an event parameter, a constant, and a system variable.

The trigger operation on the variable usage option corresponding to the target page component can be a click operation, a long press operation, a drag operation, or the like. However, the disclosure is not limited thereto. For example, as shown in FIG. 37, a user can trigger a variable usage option 34121 corresponding to the target page component, and the computer device displays a variable usage page 3413 in response to the trigger operation on the variable usage option 34121 corresponding to the target page component (for example, the page component 34113). The variable usage page 3413 includes a second parameter list 34131. The second parameter list 34131 includes a variable 34137. A variable type of the variable 34137 can be a global variable type.

In some embodiments, when the second parameter list 34131 includes a variable corresponding to the input parameter variable type, a variable corresponding to the page variable type, and a variable corresponding to the global variable type, the variable corresponding to the input parameter variable type, the variable corresponding to the page variable type, and the variable corresponding to the global variable type are all variables after variable value assignment. In response to the trigger operation on the target variable type (a trigger operation on a global variable in FIG. 37), the variable corresponding to the target variable type can be displayed. The variable corresponding to the target variable type includes the variable 34137 (for example, the target variable to which the value has been assigned).

Operation 3308: Display, in an expression display area of the variable usage page in a case that the target variable to which the value has been assigned in the second parameter list is selected, a syntax expression corresponding to the target variable to which the value has been assigned.

As shown in FIG. 37, when the target variable (for example, a variable 10137) to which the variable value has been assigned in the second parameter list 34131 is selected, a syntax expression 34136 corresponding to the target variable to which the variable value has been assigned is displayed in an expression display area 34132 of the variable usage page 3413.

In some embodiments, the variable usage page 3413 further includes an expression validation option 34134. In response to the trigger operation on the expression validation option 34134, the debugging result of the syntax expression 34136 corresponding to the target variable to which a value has been assigned can be outputted in a debugging result output area 10133 of the variable usage page.

Operation 3309: Bind, in response to a confirmation operation on the target variable to which the value has been assigned, the target page component to the target variable to which the value has been assigned.

The confirmation operation on the target variable to which a value has been assigned can be a trigger operation on the confirmation component of the variable usage page. For example, in FIG. 37, the variable usage page includes a confirmation component 34135. In response to a trigger operation on the confirmation component 34135 (for example, the trigger operation can be a click operation, a long press operation, or a sliding operation), the target variable to which a value has been assigned can be bound to the target page component (for example, the variable 34137 can be bound to the page component 34113).

Operation 3310: Render and display, in the application editing page in response to a trigger operation on a running component in the application editing page, the target variable to which the value has been assigned.

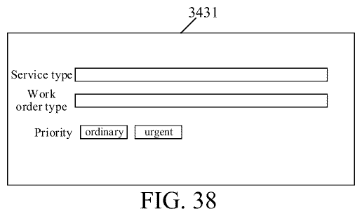

When the target variable to which a value has been assigned is bound to the target page component, in response to the trigger operation on the running component in the application editing page, the target page component that is bound to the target variable to which the value has been assigned can be rendered and displayed in the application editing page. This may be understood as: the variable value of the target variable to which a value has been assigned can be rendered in the application editing page, and then displayed on the target page component that is bound to the target variable to which a value has been assigned. For example, if the variable value of the target variable to which a value has been assigned is user information of a user, the variable value of the target variable to which a value has been assigned can be rendered and displayed on the target page component, for example, the user information of the user is displayed on the target page component. For example, as shown in FIG. 38, in response to the trigger operation on the running component in the application editing page, an application page 3431 may be displayed. The target page component (for example, a service type component) of the displayed application page 3431 is displayed after rendering the target variable to which a value has been assigned.

In response to the trigger operation on the running component in the application editing page, the application page of the target application is in the running state. When the computer device triggers the target action event in operations 3303 and 3304, the variable value can be assigned to the target variable, and then the target page component that is bound to the target variable to which the value has been assigned is rendered and displayed.

By binding the target variable to the target page, instead of calling two interfaces to respectively obtain corresponding data, one interface can be called to obtain corresponding data. Besides, data returned by the interface is assigned to the variable structure of the corresponding variable, to reduce one request by rendering different structures of the variable in the application page.

In some embodiments, an application editing page is displayed, and a variable creation page corresponding to a variable type indicated by a variable creation component is displayed in response to a trigger operation on the variable creation component in the application editing page. The application editing page includes an application page of a target application, and the application page includes one or more page components. A target variable corresponding to the variable type is displayed in the variable creation page in response to a variable definition operation triggered on the variable creation page. An action event configuration page corresponding to an action adding component is displayed in response to a trigger operation on the action adding component in the application editing page. In response to a trigger operation on the target action event of at least one action event, action configuration information corresponding to the target variable is displayed in an action configuration page corresponding to a target action event. A variable usage option corresponding to the target page component is displayed in the application editing page in a case that a target page component of the one or more page components is selected. A variable usage page is displayed in response to a trigger operation on the variable usage option corresponding to the target page component, where the variable usage page includes a second parameter list. A syntax expression corresponding to the target variable to which the variable value has been assigned is displayed in an expression display area of the variable usage page in a case that the target variable to which the variable value has been assigned in the second parameter list is selected. In response to a confirmation operation on the target variable to which the variable value has been assigned, the target page component is bound to the target variable to which the variable value has been assigned. The target variable to which the value has been assigned is rendered and displayed in the application editing page in response to a trigger operation on a running component in the application editing page. Visual presentation is used from variable definition to variable usage, thereby reducing the technical complexity from variable definition to variable usage.

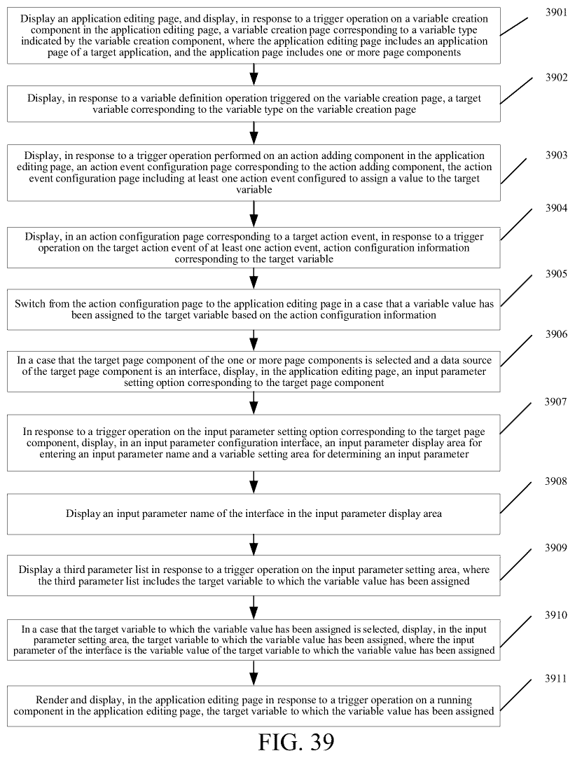

FIG. 39 is a schematic flowchart of a page processing method according to some embodiments. The page processing method can be performed by a computer device, and may include the following operation 3901 to operation 3911:

Operation 3901: Display an application editing page, and display, in response to a trigger operation on a variable creation component in the application editing page, a variable creation page corresponding to a variable type indicated by the variable creation component. The application editing page includes an application page of a target application, and the application page includes one or more page components.

Operation 3902: Display, in response to a variable definition operation triggered on the variable creation page, a target variable corresponding to the variable type in the variable creation page.

Operation 3903: Display, in response to a trigger operation on an action adding component in the application editing page, an action event configuration page corresponding to the action adding component, the action event configuration page including at least one action event configured to assign a value to the target variable.

Operation 3904: Display, in an action configuration page corresponding to a target action event, in response to a trigger operation on the target action event of at least one action event, action configuration information corresponding to the target variable.

Operation 3905: Switch from the action configuration page to display the application editing page in a case that a value has been assigned to the target variable based on the action configuration information.

Operation 3906: In a case that the target page component of the one or more page components is selected and a data source of the target page component is an interface, display, in the application editing page, an input parameter setting option corresponding to the target page component.

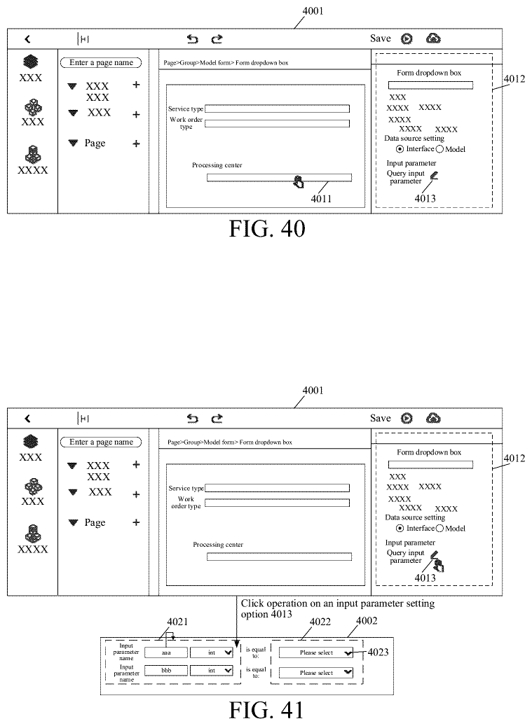

In some embodiments, when a target page component of one or more page components is selected, the attribute information corresponding to the target page component can be displayed in the attribute display area of the application editing page, and the attribute information includes a data source of the target page component. When the data source of the target page component is an interface, the input parameter setting option corresponding to the target page component is displayed in the attribute display area of the application editing page. The attribute display area can be any area of the application editing page. For example, as shown in FIG. 40, when a page component 4011 (for example, the target page component) is selected, attribute information corresponding to the page component 4011 can be displayed in an attribute display area 4012 of an application editing page 4001. The attribute information includes a data source of the page component 4011, for example, in FIG. 40, the data source of the page component 4011 is an interface, and an input parameter setting option 4013 corresponding to the target page component is displayed in the attribute display area 4012 of the application editing page.

One or more data sources are displayed in the data source setting area of the attribute display area 4012, and the data sources can be models, interfaces, variables, and the like. If the data source of the target page component is a target data source, the target source is highlighted in the data source setting area. For example, in FIG. 40, when the data source of the target page component is an interface (for example, the target data source), the interface is highlighted in the data source setting area (for example, the interface is highlighted through selection).

The highlighting in some embodiments may be implemented through selection, being bold, enlarging, and the like. However, the disclosure is not limited thereto.

Operation 3907: In response to a trigger operation on the input parameter setting option corresponding to the target page component, display, in an input parameter configuration interface, an input parameter display area for entering an input parameter name and a variable setting area for determining an input parameter.

The trigger operation may be a click operation, a long press operation, a drag operation, or an input operation of a gesture (such as an OK gesture or an M gesture) on the input parameter setting option. For example, as shown in FIG. 41, a user can click on the input parameter setting option corresponding to the target page component. In response to a click operation on the input parameter setting option 4013 corresponding to the target page component, an input parameter display area 1221 for entering an input parameter name and a variable setting area 4022 for determining an input parameter are displayed in the input parameter configuration interface 4002.

Operation 3908: Display an input parameter name of the interface in the input parameter display area.

The parameter used by the interface is called for the input parameter setting of the interface. In response to the trigger operation on the input parameter setting option corresponding to the target page component, the input parameter name of the interface can be automatically displayed directly in the input parameter display area. For example, in FIG. 41, one input parameter name of the interface is displayed as aaa in the input parameter display area, and another input parameter name is bbb. In some embodiments, the data type of the input parameter can be displayed in the input parameter display area 4021 (two input parameter names are both int in FIG. 41).

Operation 3909: Display a third parameter list in response to a trigger operation on the input parameter setting area, where the third parameter list includes the target variable to which the value has been assigned.

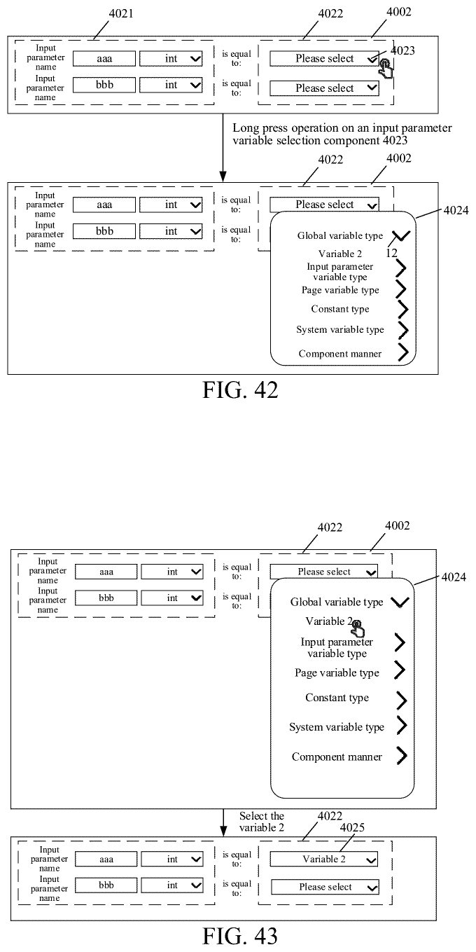

As shown in FIG. 41, the variable setting area 4022 includes an input parameter variable selection component 4023, and the trigger operation may be a click operation, a long press operation, or the like on the input parameter variable selection component 4023. For example, as shown in FIG. 42, in response to a long press operation on the input parameter variable selection component 4023, a third parameter list 4024 is displayed. The third parameter list includes a variable corresponding to the global variable type, a constant variable, a variable corresponding to the input parameter variable type, a constant, a variable corresponding to the system variable type, and a parameter value corresponding to a component method. The variable corresponding to the global variable type includes the variable 2 (for example, the target variable to which a value has been assigned). A view option (for example, 12 in FIG. 42) corresponding to the global variable type may be triggered. In response to the trigger operation on the view option, the variable 2 corresponding to the global variable type is displayed. Certainly, in some embodiments, the variable 2 can be directly displayed in the third parameter list.

The third parameter list may include one or more of a variable corresponding to the global variable type, a constant variable, a variable corresponding to the input parameter variable type, a constant, a variable corresponding to the system variable type, a parameter value corresponding to a component method, and a variable corresponding to the page variable type. Certainly, the third parameter list may further include other parameters (such as values corresponding to event parameters).

The displaying the third parameter list in response to the trigger operation on the input parameter setting area may include but is not limited to: displaying the third parameter list in the input parameter setting area; displaying the third parameter list in the input parameter selection page; and displaying the third parameter list in the input parameter setting page, for example, in FIG. 42, the third parameter list is displayed in the input parameter setting page.

Operation 3910: In a case that the target variable to which the value has been assigned is selected, display, in the input parameter setting area, the target variable to which the value has been assigned. The input parameter of the interface is the variable value of the target variable to which the variable value has been assigned.

For example, in FIG. 43, when the variable 2 (for example, the target variable to which a value has been assigned) is selected, the variable 2 is displayed in the input parameter setting area 4022. In some embodiments, the variable 2 can be displayed in the input parameter setting box 4025 in the input parameter setting area.

Operation 3911: Render and display, in the application editing page in response to a trigger operation on a running component in the application editing page, the target variable to which the value has been assigned.

When the target variable to which a value has been assigned is used as the input parameter of the interface, the rending and displaying, in the application editing page, the target variable to which a value has been assigned may include: transferring, to an interface as an input parameter of the interface, the variable value of the target variable to which a value has been assigned, and when transferring, to an interface as an input parameter of the interface, the variable value of the target variable to which a value has been assigned, displaying an interface page of the interface.

This may be understood as: the variable value of the target variable to which a value has been assigned can be rendered in the application editing page, and the variable value of the target variable to which a value has been assigned is transferred to the interface as the input parameter of the interface, so that the interface can be called to obtain data used by the target page component. In response to the trigger operation on the running component in the application editing page, the application page of the target application is in the running state. When the computer device triggers the target action event in operations 3903 to 3904, the variable value can be assigned to the target variable, and then the variable value of the target variable to which the value has been assigned is transferred to the interface as an input parameter of the interface.

In some embodiments, an application editing page is displayed, and a variable creation page corresponding to a variable type indicated by a variable creation component is displayed in response to a trigger operation on the variable creation component in the application editing page. The application editing page includes an application page of a target application, and the application page includes one or more page components. A target variable corresponding to the variable type is displayed in the variable creation page in response to a variable definition operation triggered on the variable creation page. An action event configuration page corresponding to an action adding component is displayed in response to a trigger operation on the action adding component in the application editing page. In response to a trigger operation on the target action event of at least one action event, action configuration information corresponding to the target variable is displayed in an action configuration page corresponding to a target action event. In a case that the target page component of the one or more page components is selected and a data source of the target page component is an interface, an input parameter setting option corresponding to the target page component is displayed in the application editing page. In response to a trigger operation on the input parameter setting option corresponding to the target page component, an input parameter display area for entering an input parameter name and a variable setting area for determining an input parameter are displayed in an input parameter configuration interface. An input parameter name of the interface is displayed in the input parameter display area. A third parameter list is displayed in response to a trigger operation on the input parameter setting area. In a case that the target variable to which the value has been assigned is selected, the target variable to which the value has been assigned is displayed in the input parameter setting area. The variable value of the target variable to which the variable value has been assigned is the input parameter of the interface. Visual presentation can be used from variable definition to variable usage, thereby reducing the technical complexity from variable definition to variable usage.

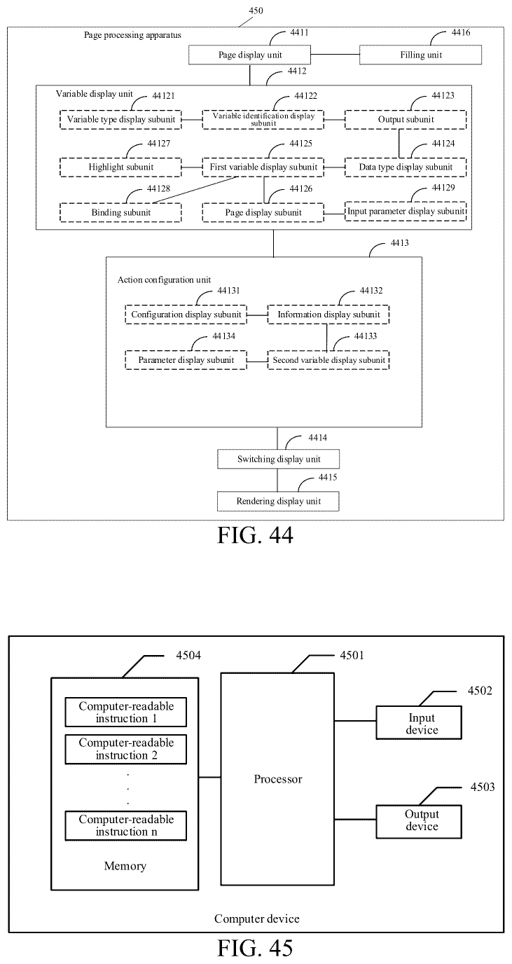

Further, FIG. 44 is a schematic structural diagram of a page processing apparatus according to some embodiments. A page processing apparatus 450 can be arranged in the computer device provided in some embodiments. The page processing apparatus 450 shown in FIG. 44 may be a computer-readable instruction (including program code) running in a computer device, and the page processing apparatus 450 may be configured to perform some or all of the operations of the method according to some embodiments shown in FIG. 4, FIG. 33, and FIG. 39. Referring to FIG. 44, the page processing apparatus may include the following units: a page display unit 4411, a variable display unit 4412, an action configuration unit 4413, a switching display unit 4414, and a rendering display unit 4415.

The page display unit 4411 is configured to display an application editing page, and display, in response to a trigger operation on a variable creation component in the application editing page, a variable creation page corresponding to a variable type indicated by the variable creation component.

The variable display unit 4412 is configured to display, in response to a variable definition operation triggered on the variable creation page, a target variable corresponding to the variable type in the variable creation page.

The action configuration unit 4413 is configured to display, in response to a trigger operation on an action adding component in the application editing page, an action event configuration page corresponding to the action adding component, the action event configuration page including at least one action event configured to assign a value to the target variable.

The action configuration unit 4413 is further configured to display, in an action configuration page corresponding to a target action event, in response to a trigger operation on the target action event of at least one action event, action configuration information corresponding to the target variable.

The switching display unit 4414 is configured to switch from the action configuration page to display the application editing page in a case that a value has been assigned to the target variable based on the action configuration information.

The rendering display unit 4415 is configured to render and display, in the application editing page in response to a trigger operation on a running component in the application editing page, the target variable to which the value has been assigned.

The variable creation component in the application editing page includes at least one of a global variable creation component, an input parameter variable creation component, or a page variable creation component, and the variable type includes: at least one of a global variable type corresponding to the global variable creation component, an input parameter variable type corresponding to the input parameter variable creation component, or a page variable type corresponding to the page variable creation component.

The variable display unit 4412 includes:
a variable type display subunit 44121, configured to display the variable type in a type display area of the variable creation page in response to the variable definition operation triggered on the variable creation page, where the displayed variable type is a variable type of an initial variable, and the initial variable is a variable to be defined in the variable creation page;
a variable identification display subunit 44122, configured to display entered target identification information in a variable identification area in response to an identification entering operation on the variable identification area in the variable creation page, where the target identification information is variable identification information of the initial variable;
an output subunit 44123, configured to output M candidate data types in response to a type trigger operation on a data type area in the variable creation page, where M is a positive integer;
a data type display subunit 44124, configured to display a target data type in a data type area in response to a type selection operation on the target data type of the M candidate data types, where the target data type is a data type of the initial variable; and
a first variable display subunit 44125, configured to use the initial variable having the target data type, the target identification information, and the variable type as the target variable, and display the target variable in the variable creation page. The target variable is a variable defined in the variable creation page.

The output subunit 44123 is configured to:
output the M candidate data types in response to a trigger operation on a type selection component in the data type area.

In some embodiments, the variable display unit 4412 is further configured to display a target variable structure of the target variable in a variable structure editing page in response to a variable structure editing operation on the variable creation page.

The switching display unit 4414 is further configured to switch from the variable structure editing page to display the variable creation page in response to a confirmation operation on the target variable structure, and display the target variable structure of the target variable in a variable structure display area of the variable creation page, where the target variable structure includes one or more target structure parameters.

The variable display unit 4412 includes:
a page display subunit 44126, configured to display the variable structure editing page in response to the variable structure editing operation on the variable creation page, where the variable structure editing page includes one or more variable structures, and one variable structure includes one or more structure parameters; and
a first variable display subunit 44125, configured to: in a case that a target variable structure of the one or more variable structures is selected, display, in a variable structure display area of the variable structure editing page, a target structure parameter included in the target variable structure.

The variable display unit 4412 includes:
a first variable display subunit 44125, configured to display one or more variable structure sources in a variable structure source area of the variable structure editing page in response to the variable structure editing operation on the variable creation page; and
a highlight subunit 44127, configured to highlight a target variable structure source of the one or more variable structure sources in the variable structure source area in response to a trigger operation on the target variable structure source;
the first variable display subunit 44125 being configured to display, in response to a trigger operation on a variable structure identification area of the variable structure editing page, one or more variable structures associated with the target variable structure source; and
the first variable display subunit 44125 being configured to: in response to a trigger operation on the target variable structure of the one or more variable structures, display an identification of the target variable structure in the variable structure identification area, and display, in a variable structure content area of the variable structure editing page, a target structure parameter included in the target variable structure.

The action configuration unit 4413 includes:
a configuration display subunit 44131, configured to display, in response to a trigger operation on the interface calling event of the at least one action event, an action configuration page corresponding to the interface calling event, where the action configuration page includes an interface calling display area and a first variable value assignment area, the interface calling display area is used to display interface information, and the first variable value assignment area is used to display the target variable to which a value is to be assigned;
an information display subunit 44132, configured to display one or more interfaces in response to an interface selection operation in the interface calling display area;
the information display subunit 44132 being further configured to display interface information of a target interface of the one or more interfaces in the interface calling display area in a case that the target interface is selected; and
a second variable display subunit 44133, configured to display a first variable list in response to a trigger operation in the first variable value assignment area, where the first variable list includes the target variable;
the second variable display subunit 44133 being configured to display, in the first variable value assignment area in a case that the target variable is selected, the target variable to which a value is to be assigned, where a variable value of the target variable to which a value has been assigned is data returned by calling the target interface.

The action configuration unit 4413 includes:
a configuration display subunit 44131, configured to display, in response to a trigger operation on the form submission event of the at least one action event, an action configuration page corresponding to the form submission event, where the action configuration page includes a form information display area and a second variable value assignment area, the form information display area is used to display form information, and the second variable value assignment area is used to display the target variable to which a value is to be assigned;
an information display subunit 44132, configured to display form information of one or more forms in response to a form selection operation in the form information display area;
the information display subunit 44132 is configured to display form information of a target form of the form information of the one or more forms in the form information display area in a case that the form information of the target form is selected; and
a second variable display subunit 44133, configured to display a second variable list in response to a trigger operation in the second variable value assignment area, where the second variable list includes the target variable;
the second variable display subunit 44133 being configured to display, in the second variable value assignment area in a case that the target variable is selected, the target variable to which a value is to be assigned, where a variable value of the target variable to which the value has been assigned is data returned when submitting the target form.

The action configuration unit 4413 includes:
a configuration display subunit 44131, configured to display, in response to a trigger operation on a variable value assignment event of the at least one action event, an action configuration page corresponding to the variable value assignment event;
a second variable display subunit 44133, configured to display, in response to a trigger operation on a variable selection area of the action configuration page, a third variable list to which a value is to be assigned, where the third variable list includes the target variable;
the second variable display subunit 44133 being configured to display, in the variable selection area of the action configuration page in a case that the target variable is selected, the target variable to which a value is to be assigned; and
a parameter display subunit 44134, configured to display an expression setting page in response to a trigger operation on a parameter expression display area of the action configuration page, where the expression setting page includes a first parameter list, the first parameter list includes one or more parameters, and the parameters include the variable to which a variable value has been assigned, a component method, an event parameter, and a constant;
the parameter display subunit 44134 being further configured to display, in an expression display area of the expression setting page in response to a parameter selection operation on a target parameter in the first parameter list, a target syntax expression corresponding to the target parameter;
the parameter display subunit 44134 being further configured to display the target parameter in a parameter display area of the action configuration page in a case that a confirmation option in the expression setting page is triggered, where a variable value of the target variable to which the value has been assigned is a parameter value corresponding to the target parameter.

The parameter display subunit 44134 is further configured to:
display a debugging result of the target syntax expression in a debugging display area of the expression setting page in a case that the expression validation option is triggered.

The variable display unit 4412 further includes:
a first variable display subunit 44125, configured to display, in the application editing page in a case that a target page component of the one or more page components is selected, a variable usage option corresponding to the target page component;
a page display subunit 44126, configured to display a variable usage page in response to a trigger operation on the variable usage option, where the variable usage page includes a second parameter list, the second parameter list includes at least one parameter, and the parameter includes: the target variable to which the value has been assigned, a component method, an event parameter, and a constant;
the first variable display subunit 44125 being configured to display, in an expression display area of the variable usage page in a case that the target variable to which the value has been assigned in the second parameter list is selected, a syntax expression corresponding to the target variable to which the variable value has been assigned; and
a binding subunit 44128, configured to bind, in response to a confirmation operation on the target variable to which the variable value has been assigned, the target page component to the target variable to which the variable value has been assigned.

The rendering display unit 4415 is configured to:
render and display, in the application editing page, the target page component bound to the target variable to which the value has been assigned.

The variable display unit 4412 further includes:
a first variable display subunit 44125, configured to: in a case that the target page component of the one or more page components is selected and a data source of the target page component is an interface, display an input parameter setting option corresponding to the target page component in the application editing page;
a page display subunit 44126, configured to: in response to a trigger operation on the input parameter setting option corresponding to the target page component, display, in an input parameter configuration interface, an input parameter display area for entering an input parameter name and a variable setting area for determining an input parameter; and
an input parameter display subunit 44129, configured to display an input parameter name of the interface in the input parameter display area;
the first variable display subunit 44125 being configured to display a third parameter list in response to a trigger operation on the input parameter setting area, where the third parameter list includes the target variable to which the variable value has been assigned;
the first variable display subunit 44125 being configured to: in a case that the target variable to which the value has been assigned is selected, display, in the input parameter setting area, the target variable to which the variable value has been assigned, where the input parameter of the interface is the variable value of the target variable to which the variable value has been assigned.

The rendering display unit 4415 is configured to:
display an interface page of the interface in a case that the variable value of the target variable to which the value has been assigned is transferred to the interface as the input parameter of the interface.

The apparatus further includes:
a filling unit 4416, configured to fill an application name of a to-be-created target application in a visual application platform in response to a trigger operation on an application creation component in the visual application platform; and
a page display unit 4411, configured to display an application editing page of the target application in the visual application platform in a case that an application editing component in the visual application platform is triggered;
the page display unit 4411 being configured to display an application page of the target application in the page display area of the application editing page in response to a trigger operation on a page creation component in the application editing page.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

In some embodiments, an application editing page is displayed, and a variable creation page corresponding to a variable type indicated by a variable creation component is displayed in response to a trigger operation on the variable creation component in the application editing page. A target variable corresponding to the variable type is displayed in the variable creation page in response to a variable definition operation triggered on the variable creation page. An action event configuration page corresponding to the action adding component is displayed in response to a trigger operation on an action adding component in the application editing page, the action event configuration page including at least one action event configured to assign a value to the target variable; In response to a trigger operation on the target action event of at least one action event, action configuration information corresponding to the target variable is displayed in an action configuration page corresponding to a target action event. The action configuration page is switched to display the application editing page in a case that a value has been assigned to the target variable based on the action configuration information. The target variable to which the value has been assigned is rendered and displayed in the application editing page in response to a trigger operation on a running component in the application editing page. Visual presentation is used from variable definition to variable usage, thereby reducing the technical complexity from variable definition to variable usage.

Further, some embodiments provide a schematic structural diagram of a computer device. The schematic structural diagram of the computer device can be shown in FIG. 45. The computer device may include: a processor 4501, an input device 4502, an output device 4503, and a memory 4504. The processor 4501, the input device 4502, the output device 4503, and the memory 4504 are connected through a bus. The memory 4504 is configured to store computer-readable instructions that include program instructions, and the processor 4501 is configured to execute the program instructions stored in the memory 4504.

In some embodiments, the processor 4501 performs the following operations by running the executable program code in the memory 4504:
displaying an application editing page, and displaying, in response to a trigger operation on a variable creation component in the application editing page, a variable creation page corresponding to a variable type indicated by the variable creation component;
displaying, in response to a variable definition operation triggered on the variable creation page, a target variable corresponding to the variable type in the variable creation page;
displaying, in response to a trigger operation on an action adding component in the application editing page, an action event configuration page corresponding to the action adding component, the action event configuration page including at least one action event configured to assign a value to the target variable;
displaying, in an action configuration page corresponding to a target action event, in response to a trigger operation on the target action event of at least one action event, action configuration information corresponding to the target variable;
switching from the action configuration page to display the application editing page in a case that a value has been assigned to the target variable based on the action configuration information; and
rendering and displaying, in the application editing page in response to a trigger operation on a running component in the application editing page, the target variable to which the value has been assigned.

The variable creation component in the application editing page includes at least one of a global variable creation component, an input parameter variable creation component, or a page variable creation component, and the variable type includes: at least one of a global variable type corresponding to the global variable creation component, an input parameter variable type corresponding to the input parameter variable creation component, or a page variable type corresponding to the page variable creation component.

When displaying, in response to a variable definition operation triggered on the variable creation page, a target variable corresponding to the variable type in the variable creation page, the processor 4501 performs the following operations:
displaying the variable type in a type display area of the variable creation page in response to the variable definition operation triggered on the variable creation page, where the displayed variable type is a variable type of an initial variable, and the initial variable is a variable to be defined in the variable creation page;
displaying entered target identification information in a variable identification area in response to an identification entering operation on the variable identification area in the variable creation page, where the target identification information is variable identification information of the initial variable;
outputting M candidate data types in response to a type trigger operation on a data type area in the variable creation page, where M is a positive integer;
displaying a target data type in the data type area in response to a type selection operation on the target data type of the M candidate data types, where the target data type is a data type of the initial variable; and
using the initial variable having the target data type, the target identification information, and the variable type as the target variable, and displaying the target variable in the variable creation page, where the target variable is a variable defined in the variable creation page.

When outputting M candidate data types in response to a type trigger operation on a data type area in the variable creation page, the processor 4501 performs the following operations:
outputting the M candidate data types in response to a trigger operation on a type selection component in the data type area.

The processor 4501 is further configured to:
display a target variable structure of the target variable in a variable structure editing page in response to a variable structure editing operation on the variable creation page; and
switch from the variable structure editing page to display the variable creation page in response to a confirmation operation on the target variable structure, and display the target variable structure of the target variable in a variable structure display area of the variable creation page, where the target variable structure includes one or more target structure parameters.

When displaying a target variable structure of the target variable in a variable structure editing page in response to a variable structure editing operation on the variable creation page, the processor 4501 performs the following operations:
displaying the variable structure editing page in response to the variable structure editing operation on the variable creation page, where the variable structure editing page includes one or more variable structures, and one variable structure includes one or more structure parameters; and
in a case that a target variable structure of the one or more variable structures is selected, displaying, in a variable structure display area of the variable structure editing page, a target structure parameter included in the target variable structure.

When displaying a target variable structure of the target variable in a variable structure editing page in response to a variable structure editing operation on the variable creation page, the processor 4501 performs the following operations:
displaying one or more variable structure sources in a variable structure source area of the variable structure editing page in response to the variable structure editing operation on the variable creation page;
highlighting a target variable structure source of the one or more variable structure sources in the variable structure source area in response to a trigger operation on the target variable structure source;
displaying, in response to a trigger operation on a variable structure identification area of the variable structure editing page, one or more variable structures associated with the target variable structure source; and
in response to a trigger operation on the target variable structure of the one or more variable structures, displaying an identification of the target variable structure in the variable structure identification area, and displaying, in a variable structure content area of the variable structure editing page, a target structure parameter included in the target variable structure.

In some embodiments, the target action event is an interface calling event, and when displaying, in an action configuration page corresponding to a target action event, in response to a trigger operation on the target action event of at least one action event, action configuration information corresponding to the target variable, the processor 4501 performs the following operations:
displaying, in response to a trigger operation on the interface calling event of the at least one action event, an action configuration page corresponding to the interface calling event, where the action configuration page includes an interface calling display area and a first variable value assignment area, the interface calling display area is used to display interface information, and the first variable value assignment area is used to display the target variable to which a value is to be assigned;
displaying one or more interfaces in response to an interface selection operation in the interface calling display area;
displaying interface information of a target interface of the one or more interfaces in the interface calling display area in a case that the target interface is selected;
displaying a first variable list in response to a trigger operation in the first variable value assignment area, where the first variable list includes the target variable; and
displaying, in the first variable value assignment area in a case that the target variable is selected, the target variable to which a value is to be assigned, where a variable value of the target variable to which a value has been assigned is data returned by calling the target interface.

The target action event is a form submission event, and when displaying, in an action configuration page corresponding to a target action event, in response to a trigger operation on the target action event of at least one action event, action configuration information corresponding to the target variable, the processor 4501 performs the following operations:
displaying, in response to a trigger operation on the form submission event of the at least one action event, an action configuration page corresponding to the form submission event, where the action configuration page includes a form information display area and a second variable value assignment area, the form information display area is used to display form information, and the second variable value assignment area is used to display the target variable to which a value is to be assigned;
displaying form information of one or more forms in response to a form selection operation in the form information display area;
displaying form information of a target form of the form information of the one or more forms in the form information display area in a case that the form information of the target form is selected;
displaying a second variable list in response to a trigger operation in the second variable value assignment area, where the second variable list includes the target variable; and
displaying, in the second variable value assignment area in a case that the target variable is selected, the target variable to which a value is to be assigned, where a variable value of the target variable to which the value has been assigned is data returned when submitting the target form.

The target action event includes a variable value assignment event, and when displaying, in an action configuration page corresponding to a target action event, in response to a trigger operation on the target action event of at least one action event, action configuration information corresponding to the target variable, the processor 4501 performs the following operations:
displaying, in response to a trigger operation on a variable value assignment event of the at least one action event, an action configuration page corresponding to the variable value assignment event;
displaying, in response to a trigger operation on a variable selection area of the action configuration page, a third variable list to which a value is to be assigned, where the third variable list includes the target variable;
displaying, in the variable selection area of the action configuration page in a case that the target variable is selected, the target variable to which a value is to be assigned;
displaying an expression setting page in response to a trigger operation on a parameter expression display area of the action configuration page, where the expression setting page includes a first parameter list, the first parameter list includes one or more parameters, and the parameters include the variable to which a variable value has been assigned, a component method, an event parameter, and a constant;
displaying, in an expression display area of the expression setting page in response to a parameter selection operation on a target parameter in the first parameter list, a target syntax expression corresponding to the target parameter; and
displaying the target parameter in a parameter display area of the action configuration page in a case that a confirmation option in the expression setting page is triggered, where a variable value of the target variable to which the value has been assigned is a parameter value corresponding to the target parameter.

In some embodiments, the expression setting page includes an expression validation option for the target syntax expression, and the processor 4501 performs the following operation:
displaying a debugging result of the target syntax expression in a debugging display area of the expression setting page in a case that the expression validation option is triggered.

In some embodiments, the application editing page includes an application page of a target application, and the application page includes one or more page components. The processor 4501 further performs the following operations:
displaying, in the application editing page in a case that a target page component of the one or more page components is selected, a variable usage option corresponding to the target page component;
displaying a variable usage page in response to a trigger operation on the variable usage option, where the variable usage page includes a second parameter list, the second parameter list includes at least one parameter, and the parameter includes: the target variable to which the value has been assigned, a component method, an event parameter, and a constant;
displaying, in an expression display area of the variable usage page in a case that the target variable to which the variable value has been assigned in the second parameter list is selected, a syntax expression corresponding to the target variable to which the variable value has been assigned; and
binding, in response to a confirmation operation on the target variable to which the variable value has been assigned, the target page component to the target variable to which the variable value has been assigned.

When rendering and displaying, in the application editing page, the target variable to which the value has been assigned, the processor 4501 performs the following operation:
rendering and displaying, in the application editing page, the target page component bound to the target variable to which the value has been assigned.

The application editing page includes an application page of a target application, and the application page includes one or more page components. The processor 4501 further performs the following operations:
in a case that the target page component of the one or more page components is selected and a data source of the target page component is an interface, displaying, in the application editing page, an input parameter setting option corresponding to the target page component;
in response to a trigger operation on the input parameter setting option corresponding to the target page component, displaying, in an input parameter configuration interface, an input parameter display area for entering an input parameter name and a variable setting area for determining an input parameter;
displaying an input parameter name of the interface in the input parameter display area;
displaying a third parameter list in response to a trigger operation on the input parameter setting area, where the third parameter list includes the target variable to which the value has been assigned; and
in a case that the target variable to which the value has been assigned is selected, displaying, in the input parameter setting area, the target variable to which the value has been assigned, where the input parameter of the interface is the variable value of the target variable to which the value has been assigned.

When rendering and displaying, in the application editing page, the target variable to which the value has been assigned, the processor 4501 performs the following operation:
displaying an interface page of the interface in a case that the variable value of the target variable to which the value has been assigned is transferred to the interface as the input parameter of the interface.

The processor 4501 further performs the following operations:
filling an application name of a to-be-created target application in a visual application platform in response to a trigger operation on an application creation component in the visual application platform;
displaying an application editing page of the target application in the visual application platform in a case that an application editing component in the visual application platform is triggered; and
displaying an application page of the target application in the page display area of the application editing page in response to a trigger operation on a page creation component in the application editing page.

In some embodiments, an application editing page is displayed, and a variable creation page corresponding to a variable type indicated by a variable creation component is displayed in response to a trigger operation on the variable creation component in the application editing page. A target variable corresponding to the variable type is displayed in the variable creation page in response to a variable definition operation triggered on the variable creation page. An action event configuration page corresponding to the action adding component is displayed in response to a trigger operation on an action adding component in the application editing page, the action event configuration page including at least one action event configured to assign a value to the target variable; In response to a trigger operation on the target action event of at least one action event, action configuration information corresponding to the target variable is displayed in an action configuration page corresponding to a target action event. The action configuration page is switched to display the application editing page in a case that a value has been assigned to the target variable based on the action configuration information. The target variable to which the value has been assigned is rendered and displayed in the application editing page in response to a trigger operation on a running component in the application editing page. Visual presentation can be used from variable definition to variable usage, thereby reducing the technical complexity from variable definition to variable usage.

Some embodiments provide a computer-readable storage medium. The computer-readable storage medium stores computer-readable instructions executed by the foregoing page processing apparatus. The computer-readable instructions include computer-readable instructions. When executing the computer-readable instructions, a processor can perform the page processing method described in some embodiments corresponding to FIG. 4, FIG. 33, or FIG. 39. Therefore, details are not repeated herein. For implementation details of the computer-readable storage medium of some embodiments, refer to the descriptions of the method. As an example, the computer-readable instruction can be deployed to be executed on one computing device, or on multiple computing devices located at one site, or on multiple computing devices distributed across multiple sites and interconnected by a communication network.

In addition, some embodiments provide a computer program product or a computer-readable instruction, which may include computer-readable instructions that may be stored in a computer-readable storage medium. A processor of a computer device reads the computer-readable instructions from the computer-readable storage medium, and the processor can execute the computer-readable instructions, so that the computer device performs the page processing method described in some embodiments corresponding to FIG. 4, FIG. 33, or FIG. 39. Therefore, details are not repeated herein. For implementation details of the computer program product or the computer-readable instructions of some embodiments, refer to the descriptions of the method.

A person of ordinary skill in the art may understand that all or some procedures in the methods in some embodiments may be implemented by a computer-readable instruction instructing relevant hardware. The program may be stored in a non-volatile computer-readable storage medium. When the program is executed, the procedures of some embodiments may be implemented. The foregoing storage medium may include a magnetic disc, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A page processing method, performed by a computer device and comprising:
displaying an application editing page, and displaying, in response to a first trigger operation on a variable creation component in the application editing page, a variable creation page corresponding to a variable type indicated by the variable creation component;
displaying, in response to a variable definition operation triggered on the variable creation page, a target variable corresponding to the variable type in the variable creation page;
displaying, in response to a second trigger operation on an action adding component in the application editing page, an action event configuration page corresponding to the action adding component, the action event configuration page comprising at least one action event configured to assign a value to the target variable;
displaying action configuration information corresponding to the target variable, in an action configuration page corresponding to a target action event, in response to a third trigger operation on the target action event;
switching from the action configuration page to display the application editing page based on the value being assigned to the target variable, wherein the value is assigned based on the action configuration information; and
rendering and displaying, in the application editing page in response to a fourth trigger operation on a running component in the application editing page, the target variable to which the value has been assigned.

2. The page processing method according to claim 1, wherein the variable creation component in the application editing page comprises at least one of a global variable creation component, an input parameter variable creation component, or a page variable creation component, and
wherein the variable type comprises: at least one of a global variable type corresponding to the global variable creation component, an input parameter variable type corresponding to the input parameter variable creation component, or a page variable type corresponding to the page variable creation component.

3. The page processing method according to claim 1, wherein the displaying the target variable in the variable creation page comprises:
displaying the variable type in a type display area of the variable creation page in response to the variable definition operation triggered on the variable creation page, wherein the variable type is a first variable type of an initial variable, and wherein the initial variable is a second variable to be defined in the variable creation page;
displaying entered target identification information in a variable identification area in response to an identification entering operation on the variable identification area in the variable creation page, wherein the target identification information is variable identification information of the initial variable;
outputting M candidate data types in response to a type trigger operation on a data type area in the variable creation page, wherein M is a positive integer;
displaying a target data type in the data type area in response to a type selection operation on the target data type of the M candidate data types, wherein the target data type is a data type of the initial variable; and
using the initial variable having the target data type, the target identification information, and the variable type as the target variable, and displaying the target variable in the variable creation page, wherein the target variable is a first variable defined in the variable creation page.

4. The page processing method according to claim 3, wherein the outputting the M candidate data types comprises:
outputting the M candidate data types in response to a fifth trigger operation on a type selection component in the data type area.

5. The page processing method according to claim 4, further comprising:
displaying a target variable structure of the target variable in a variable structure editing page in response to a variable structure editing operation on the variable creation page; and
switching from the variable structure editing page to display the variable creation page in response to a confirmation operation on the target variable structure, and displaying the target variable structure of the target variable in a first variable structure display area of the variable creation page, wherein the target variable structure comprises one or more target structure parameters.

6. The page processing method according to claim 5, wherein the displaying the target variable structure comprises:
displaying the variable structure editing page in response to the variable structure editing operation on the variable creation page, wherein the variable structure editing page comprises one or more variable structures, and one variable structure comprises one or more structure parameters; and
based on a first target variable structure of the one or more variable structures being selected, displaying, in a second variable structure display area of the variable structure editing page, a target structure parameter from the first target variable structure.

7. The page processing method according to claim 5, wherein the displaying the target variable structure comprises:
displaying one or more variable structure sources in a variable structure source area of the variable structure editing page in response to the variable structure editing operation on the variable creation page;
highlighting a target variable structure source of the one or more variable structure sources in the variable structure source area in response to a sixth trigger operation on the target variable structure source;
displaying, in response to a seventh trigger operation on a variable structure identification area of the variable structure editing page, one or more variable structures associated with the target variable structure source; and
in response to an eighth trigger operation on the target variable structure of the one or more variable structures, displaying an identification of the target variable structure in the variable structure identification area, and displaying, in a variable structure content area of the variable structure editing page, a target structure parameter comprised in the target variable structure.

8. The page processing method according to claim 1, wherein the target action event is an interface calling event, and the displaying the action configuration information comprises:
displaying, in response to a fifth trigger operation on the interface calling event of the at least one action event, a first action configuration page corresponding to the interface calling event, wherein the first action configuration page comprises an interface calling display area and a first variable value assignment area, the interface calling display area being used to display interface information, and the first variable value assignment area being used to display the target variable to which the value is to be assigned;
displaying one or more interfaces in response to an interface selection operation in the interface calling display area;
displaying interface information of a target interface of the one or more interfaces in the interface calling display area based on the target interface being selected;
displaying a first variable list in response to a sixth trigger operation in the first variable value assignment area, wherein the first variable list comprises the target variable; and
displaying, in the first variable value assignment area based on the target variable being selected, the target variable to which the value is to be assigned, wherein a variable value of the target variable to which the value has been assigned is data returned by calling the target interface.

9. The page processing method according to claim 1, wherein the target action event is a form submission event, and the displaying, the action configuration information comprises:
displaying, in response to a fifth trigger operation on the form submission event of the at least one action event, a first action configuration page corresponding to the form submission event, wherein the first action configuration page comprises a form information display area and a second variable value assignment area, the form information display area being used to display form information, and the second variable value assignment area being used to display the target variable to which the value is to be assigned;
displaying first form information of one or more forms in response to a form selection operation in the form information display area;
displaying second form information of a target form of the first form information in the form information display area based on the second form information being selected;
displaying a second variable list in response to a sixth trigger operation in the second variable value assignment area, wherein the second variable list comprises the target variable; and
displaying, in the second variable value assignment area based on the target variable being selected, the target variable to which the value is to be assigned, wherein a variable value of the target variable to which the value has been assigned is data returned when submitting the target form.

10. The page processing method according to claim 1, wherein the target action event comprises a variable value assignment event, and the displaying the action configuration information comprises:
displaying, in response to a fifth trigger operation on a first variable value assignment event of the at least one action event, a first action configuration page corresponding to the first variable value assignment event;
displaying, in response to a sixth trigger operation on a variable selection area of the first action configuration page, a third variable list to which the value is to be assigned, wherein the third variable list comprises the target variable;
displaying, in the variable selection area of the first action configuration page in based on the target variable being selected, the target variable to which the value is to be assigned;
displaying an expression setting page in response to a seventh trigger operation on a parameter expression display area of the first action configuration page, wherein the expression setting page comprises a first parameter list, the first parameter list comprises one or more parameters, and the one or more parameters comprise the target variable to which a variable value has been assigned, a component method, an event parameter, and a constant;
displaying, in an expression display area of the expression setting page in response to a parameter selection operation on a target parameter in the first parameter list, a target syntax expression corresponding to the target parameter; and
displaying the target parameter in a parameter display area of the first action configuration page based on a confirmation option in the expression setting page being triggered, wherein the variable value is a parameter value corresponding to the target parameter.

11. A page processing apparatus, comprising:
at least one memory configured to store computer program code; and
at least one processor configured to read the program code and operate as instructed by the program code, the program code comprising:
page display code configured to cause at least one of the at least one processor to display an application editing page, and display, in response to a first trigger operation on a variable creation component in the application editing page, a variable creation page corresponding to a variable type indicated by the variable creation component;
variable display code configured to cause at least one of the at least one processor to display, in response to a variable definition operation triggered on the variable creation page, a target variable corresponding to the variable type in the variable creation page;
first action configuration code configured to cause at least one of the at least one processor to display, in response to a second trigger operation on an action adding component in the application editing page, an action event configuration page corresponding to the action adding component, the action event configuration page comprising at least one action event configured to assign a value to the target variable;
second action configuration code configured to cause at least one of the at least one processor to display action configuration information corresponding to the target variable, in an action configuration page corresponding to a target action event, in response to a third trigger operation on the target action event;
switching display code configured to cause at least one of the at least one processor to switch from the action configuration page to display the application editing page based on the value being assigned to the target variable, wherein the value is assigned based on the action configuration information; and
a rendering display code configured to cause at least one of the at least one processor to render and display, in the application editing page in response to a fourth trigger operation on a running component in the application editing page, the target variable to which the value has been assigned.

12. The page processing apparatus according to claim 11, wherein the variable creation component in the application editing page comprises at least one of a global variable creation component, an input parameter variable creation component, or a page variable creation component, and
wherein the variable type comprises: at least one of a global variable type corresponding to the global variable creation component, an input parameter variable type corresponding to the input parameter variable creation component, or a page variable type corresponding to the page variable creation component.

13. The page processing apparatus according to claim 11, wherein the variable display code is configured to cause at least one of the at least one processor to:
display the variable type in a type display area of the variable creation page in response to the variable definition operation triggered on the variable creation page, wherein the variable type is a first variable type of an initial variable, and wherein the initial variable is a second variable to be defined in the variable creation page;
display entered target identification information in a variable identification area in response to an identification entering operation on the variable identification area in the variable creation page, wherein the target identification information is variable identification information of the initial variable;
output M candidate data types in response to a type trigger operation on a data type area in the variable creation page, wherein M is a positive integer;
display a target data type in the data type area in response to a type selection operation on the target data type of the M candidate data types, wherein the target data type is a data type of the initial variable; and
use the initial variable having the target data type, the target identification information, and the variable type as the target variable, and display the target variable in the variable creation page, wherein the target variable is a first variable defined in the variable creation page.

14. The page processing apparatus according to claim 13, wherein the variable display code is configured to cause at least one of the at least one processor to:
output the M candidate data types in response to a fifth trigger operation on a type selection component in the data type area.

15. The page processing apparatus according to claim 14, wherein the program code further comprises target variable structure code configured to cause at least one of the at least one processor to:
display a target variable structure of the target variable in a variable structure editing page in response to a variable structure editing operation on the variable creation page; and
switch from the variable structure editing page to display the variable creation page in response to a confirmation operation on the target variable structure, and displaying the target variable structure of the target variable in a first variable structure display area of the variable creation page, wherein the target variable structure comprises one or more target structure parameters.

16. The page processing apparatus according to claim 15, wherein the target variable structure code is configured to cause at least one of the at least one processor to:
display the variable structure editing page in response to the variable structure editing operation on the variable creation page, wherein the variable structure editing page comprises one or more variable structures, and one variable structure comprises one or more structure parameters; and
based on a first target variable structure of the one or more variable structures being selected, display, in a second variable structure display area of the variable structure editing page, a target structure parameter from the first target variable structure.

17. The page processing apparatus according to claim 15, wherein the target variable structure code is configured to cause at least one of the at least one processor to:
display one or more variable structure sources in a variable structure source area of the variable structure editing page in response to the variable structure editing operation on the variable creation page;
highlight a target variable structure source of the one or more variable structure sources in the variable structure source area in response to a sixth trigger operation on the target variable structure source;
display, in response to a seventh trigger operation on a variable structure identification area of the variable structure editing page, one or more variable structures associated with the target variable structure source; and
in response to an eighth trigger operation on the target variable structure of the one or more variable structures, display an identification of the target variable structure in the variable structure identification area, and display, in a variable structure content area of the variable structure editing page, a target structure parameter comprised in the target variable structure.

18. The page processing apparatus according to claim 11, wherein the target action event is an interface calling event, and the displaying the action configuration information comprises:
displaying, in response to a fifth trigger operation on the interface calling event of the at least one action event, a first action configuration page corresponding to the interface calling event, wherein the first action configuration page comprises an interface calling display area and a first variable value assignment area, the interface calling display area being used to display interface information, and the first variable value assignment area being used to display the target variable to which the value is to be assigned;
displaying one or more interfaces in response to an interface selection operation in the interface calling display area;
displaying interface information of a target interface of the one or more interfaces in the interface calling display area based on the target interface being selected;
displaying a first variable list in response to a sixth trigger operation in the first variable value assignment area, wherein the first variable list comprises the target variable; and
displaying, in the first variable value assignment area based on the target variable being selected, the target variable to which the value is to be assigned, wherein a variable value of the target variable to which the value has been assigned is data returned by calling the target interface.

19. The page processing apparatus according to claim 11, wherein the target action event is a form submission event, and wherein the second action configuration code is configured to cause at least one of the at least one processor to:
display, in response to a fifth trigger operation on the form submission event of the at least one action event, a first action configuration page corresponding to the form submission event, wherein the first action configuration page comprises a form information display area and a second variable value assignment area, the form information display area being used to display form information, and the second variable value assignment area being used to display the target variable to which the value is to be assigned;
display first form information of one or more forms in response to a form selection operation in the form information display area;
display second form information of a target form of the first form information in the form information display area based on the second form information being selected;
display a second variable list in response to a sixth trigger operation in the second variable value assignment area, wherein the second variable list comprises the target variable; and
display, in the second variable value assignment area based on the target variable being selected, the target variable to which the value is to be assigned, wherein a variable value of the target variable to which the value has been assigned is data returned when submitting the target form.

20. A non-transitory computer-readable storage medium, storing computer code which, when executed by at least one processor, causes the at least one processor to at least:
display an application editing page, and display, in response to a first trigger operation on a variable creation component in the application editing page, a variable creation page corresponding to a variable type indicated by the variable creation component;
display, in response to a variable definition operation triggered on the variable creation page, a target variable corresponding to the variable type in the variable creation page;
display, in response to a second trigger operation on an action adding component in the application editing page, an action event configuration page corresponding to the action adding component, the action event configuration page comprising at least one action event configured to assign a value to the target variable;
display action configuration information corresponding to the target variable, in an action configuration page corresponding to a target action event, in response to a third trigger operation on the target action event;
switch from the action configuration page to display the application editing page based on the value being assigned to the target variable, wherein the value is assigned based on the action configuration information; and
render and display, in the application editing page in response to a fourth trigger operation on a running component in the application editing page, the target variable to which the value has been assigned.
